(19) United States
(12) Patent Application Publication
(10) Pub. No.: US 2024/0320546 A1
(43) Pub. Date: Sep. 26, 2024

(54) MACHINE LEARNING MODEL TRAINING FOR IMPROVING ANOMALY DETECTION

(71) Applicant: UnitedHealth Group Incorporated, Minnetonka, MN (US)

(72) Inventors: Aldo Cordova Palomera, San Diego, CA (US); Brian Lawrence Hill, Culver City, CA (US); Eran Halperin, Santa Monica, CA (US); Ardavan Saeedi, Jersey City, NJ (US)

(21) Appl. No.: 18/189,039

(22) Filed: Mar. 23, 2023

(51) Int. Cl. G06N 20/00

(52) U.S. Cl. CPC G06N 20/00

(57) ABSTRACT

Various embodiments of the present disclosure provide methods, apparatus, systems, computing devices, computing entities, and/or the like for improving machine learning model training based on receiving labeled training data objects, generating a normal prediction loss parameter, generating a global classification loss parameter, generating a composite loss parameter, and initiating the performance of one or more prediction-based operations.

### BACKGROUND

A machine learning model refers to a computer software program that may analyze data objects. Many machine learning models are plagued with technical challenges and difficulties such as, low accuracy and low reliability in generating predictions.

### BRIEF SUMMARY

In general, various embodiments of the present disclosure provide methods, apparatus, systems, computing devices, computing entities, and/or the like for addressing technical challenges and difficulties related to, for example, but not limited to, training machine learning models for detecting anomaly data objects. For example, various embodiments of the present disclosure provide technical benefits and advantages such as, but not limited to, improving accuracy and reliability of machine learning models in predicting classification labels of data objects.

In some embodiments, a computer-implemented method comprises: receiving, by one or more processors, a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label; generating, by the one or more processors and using an anomaly detection machine learning model and the plurality of labeled training data objects, (a) a normal prediction loss parameter associated with the normal classification label and (b) an anomaly prediction loss parameter associated with the anomaly classification label; generating, by the one or more processors and using a classification prediction machine learning model, a global classification loss parameter based on the plurality of labeled training data objects, the normal prediction loss parameter, and the anomaly prediction loss parameter; generating, by the one or more processors, a composite loss parameter based on the normal prediction loss parameter, the global classification loss parameter, a normal prediction weight parameter, and a global classification weight parameter; and initiating, by the one or more processors, the performance of one or more prediction-based operations based on the anomaly detection machine learning model and the composite loss parameter.

In some embodiments, a computing apparatus comprising memory and one or more processors communicatively coupled to the memory, the one or more processors configured to: receive a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label; generate, using an anomaly detection machine learning model and the plurality of labeled training data objects, (a) a normal prediction loss parameter associated with the normal classification label and (b) an anomaly prediction loss parameter associated with the anomaly classification label; generate, using a classification prediction machine learning model, a global classification loss parameter based on the plurality of labeled training data objects, the normal prediction loss parameter, and the anomaly prediction loss parameter; generate a composite loss parameter based on the normal prediction loss parameter, the global classification loss parameter, a normal prediction weight parameter, and a global classification weight parameter; and initiate the performance of one or more prediction-based operations based on the anomaly detection machine learning model and the composite loss parameter.

In some embodiments, one or more non-transitory computer-readable storage media including instructions that, when executed by one or more processors, cause the one or more processors to: receive a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label; generate, using an anomaly detection machine learning model and the plurality of labeled training data objects, (a) a normal prediction loss parameter associated with the normal classification label and (b) an anomaly prediction loss parameter associated with the anomaly classification label; generate, using a classification prediction machine learning model, a global classification loss parameter based on the plurality of labeled training data objects, the normal prediction loss parameter, and the anomaly prediction loss parameter; generate a composite loss parameter based on the normal prediction loss parameter, the global classification loss parameter, a normal prediction weight parameter, and a global classification weight parameter; and initiate the performance of one or more prediction-based operations based on the anomaly detection machine learning model and the composite loss parameter.

### BRIEF DESCRIPTION OF THE DRAWINGS

FIG. 1 provides an example overview of an architecture in accordance with some embodiments of the present disclosure.

FIG. 2 provides an example classification label prediction computing entity in accordance with some embodiments of the present disclosure.

FIG. 3 provides an example client computing entity in accordance with some embodiments of the present disclosure.

FIG. 4 provides examples of labeled training data objects in accordance with some embodiments of the present disclosure.

FIG. 5 provides an operational example of an anomaly detection machine learning model in accordance with some embodiments discussed herein.

FIG. 6 provides an operational example of a classification prediction machine learning model in accordance with some embodiments discussed herein.

FIG. 7 is a flowchart diagram of an example method for optimizing anomaly detection by an example anomaly detection machine learning model in accordance with some embodiments discussed herein.

FIG. 8 is a flowchart diagram of an example method for generating normal prediction loss parameters in accordance with some embodiments discussed herein.

FIG. 9 is a flowchart diagram of an example method for generating anomaly prediction loss parameters in accordance with some embodiments discussed herein.

FIG. 10 is a flowchart diagram of an example method for generating composite loss parameters in accordance with some embodiments discussed herein.

FIG. 11 provides an operational example of a framework for an example classification label prediction system in accordance with some embodiments discussed herein.

FIG. 12 is a flowchart diagram of an example method for training an example anomaly detection machine learning model in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based at least in part only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

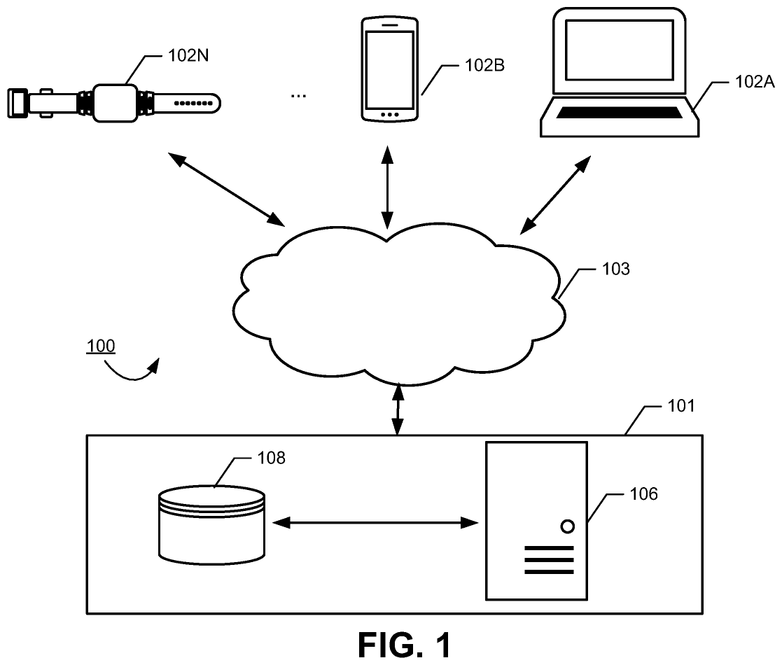

Referring now to FIG. 1, a schematic diagram of an example architecture 100 for performing predictive data analysis is illustrated. In the example shown in FIG. 1, the example architecture 100 comprises a data object prediction platform/system 101 that may receive data object predictive analysis requests from other computing entities (such as, but not limited to, the client computing entity 102A, the client computing entity 102B, . . . , client computing entity 102N), process the data object predictive analysis requests to generate one or more predictions (such as, but not limited to, one or more predicted classification labels), and automatically perform or initiate the performance of one or more prediction-based operations based on the generated predictions. In some embodiments, the data object prediction platform/system 101 may transmit the generated predictions to the other computing entities (such as, but not limited to, the client computing entity 102A, the client computing entity 102B, . . . , the client computing entity 102N).

In some embodiments, the data object prediction platform/system 101 communicates with at least one of the client computing entities (such as, but not limited to, the client computing entity 102A, the client computing entity 102B, . . . , the client computing entity 102N) through one or more communication channels using one or more communication networks such as, but not limited to, the networks 103. In some embodiments, the networks 103 may include, but not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. In some embodiments, the networks 103 may have any suitable communication range associated therewith and may include, for example, global networks (e.g., the Internet), MANs, WANs, LANs, or PANs. In some embodiments, the networks 103 may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities. In some embodiments, the networks 103 may utilize a variety of networking protocols including, but not limited to, TCP/IP based networking protocols. In some embodiments, the protocol may be a custom protocol of JavaScript Object Notation (JSON) objects sent via a WebSocket channel. In some embodiments, the protocol is JSON over RPC, JSON over REST/HTTP, and/or the like.

In the example shown in FIG. 1, the data object prediction platform/system 101 includes a classification label prediction computing entity 106 and a training data object storage entity 108. In some embodiments, the classification label prediction computing entity 106 may receive one or more data object predictive analysis requests from other computing entities (such as, but not limited to, one of more of the client computing entity 102A, the client computing entity 102B, . . . , the client computing entity 102N), and the one or more data object predictive analysis requests comprise electronic requests to predict one or more classification labels associated with one or more data objects, process the one or more data object predictive analysis requests to generate predictions that include, but are not limited to, predicted classification labels associated with the one or more data objects, and automatically perform or initiate the performance of one or more prediction-based operations based on the generated predictions that include, but are not limited to, predicted classification labels associated with the one or more data objects. In some embodiments, the classification label prediction computing entity 106 transmits the generated predictions (such as, but not limited to, the predicted classification labels) to other computing entities (such as, but not limited to, one or more of the client computing entity 102A, the client computing entity 102B, . . . , the client computing entity 102N).

In some embodiments, one or more machine learning models are deployed by the data object prediction platform/system 101 to generate the one or more predictions in response to the data object predictive analysis requests from other computing entities (such as, but not limited to, one of more of the client computing entity 102A, the client computing entity 102B, . . . , the client computing entity 102N). For example, the classification label prediction computing entity 106 of the data object prediction platform/system 101 may deploy one or more machine learning models to predict one or more classification labels associated with one or more data objects. In some embodiments, the data object prediction platform/system 101 and/or the classification label prediction computing entity 106 may automatically perform or initiate the performance of one or more prediction-based operations based on training one or more machine learning models.

In the present disclosure, training an example machine learning model refers to an example process of inputting one or more labeled training data objects to the example machine learning model and causing adjustments of one or more machine learning model parameters associated with the machine learning model. In some embodiments, the example process of training an example machine learning model generates a trained machine learning model that can be validated, tested, and deployed. In some embodiments, training the example machine learning model may provide various technical benefits and advantages such as, but not limited to, identifying optimized values associated with the machine learning model parameters for generating accurate and reliable predictions. As such, training the machine learning model may improve the accuracy and reliability of the predictions generated by the machine learning model, and may further improve the performance of the prediction-based operations.

In some embodiments, the training data object storage entity 108 stores labeled training data objects that are used by the classification label prediction computing entity 106 for training the one or more machine learning model. In some embodiments, the training data object storage entity 108 may include one or more storage units, such as multiple distributed storage units that are connected through a computer network. In some embodiments, each storage unit in the training data object storage entity 108 may store at least one of one or more data assets associated with the labeled training data objects and/or one or more data about the computed properties of the one or more data assets. In some embodiments, each storage unit in the training data object storage entity 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Classification Label Prediction Computing Entity

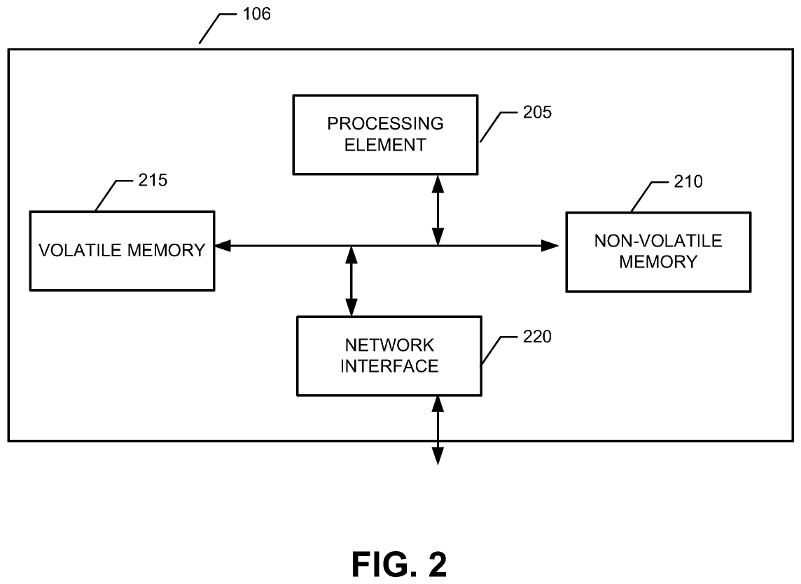

Referring now to FIG. 2, an example illustrative schematic of an example classification label prediction computing entity 106 according to some embodiments of the present disclosure is illustrated.

In general, the terms computing entity, computer, entity, device, system, and/or similar words used herein interchangeably refers to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating, generating, monitoring, evaluating, comparing, and/or similar terms used herein interchangeably. In some embodiments, these functions, operations, and/or processes can be performed on data, content, information, and/or similar terms used herein interchangeably.

In some embodiments, the classification label prediction computing entity 106 comprises, or is in communication with, one or more processing elements 205 (also referred to as processors, processing circuitry, and/or similar terms used herein interchangeably) that communicate with other elements within the classification label prediction computing entity 106 (for example, via a bus), as shown in the example illustrated in FIG. 2. In some embodiments, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Additionally, or alternatively, the processing element 205 may be embodied as one or more other processing devices or circuitry. In the present disclosure, the term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. In some embodiments, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the classification label prediction computing entity 106 comprises, or is in communication with, non-volatile media (also referred to as non-volatile storage, memory, memory storage, memory circuitry and/or similar terms used herein interchangeably), as shown in the example illustrated in FIG. 2. In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. In some embodiments, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the classification label prediction computing entity 106 comprises, or is in communication with, volatile media (also referred to as volatile storage, memory, memory storage, memory circuitry and/or similar terms used herein interchangeably), as shown in the example illustrated in FIG. 2. In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. In some embodiments, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the classification label prediction computing entity 106 with the assistance of the processing element 205 and operating system.

In some embodiments, the classification label prediction computing entity 106 includes one or more network interfaces 220 for communicating with various computing entities, such as by communicating data, content, information, and/or similar terms used herein interchangeably that can be transmitted, received, operated on, processed, displayed, stored, and/or the like, as shown in the example illustrated in FIG. 2. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the classification label prediction computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

While the description above provides example elements of an example classification label prediction computing entity, it is noted that the scope of the present disclosure is not limited to the description above. In some examples, an example classification label prediction computing entity 106 may comprise one or more additional and/or alternative elements. For example, the classification label prediction computing entity 106 may include, or be in communication with, one or more input elements, such as a keyboard input, a mouse input, a touch screen/display input, a motion input, a movement input, an audio input, a pointing device input, a joystick input, a keypad input, and/or the like. Additionally, or alternatively, the classification label prediction computing entity 106 may include, or be in communication with, one or more output elements (not shown), such as an audio output, a video output, a screen/display output, a motion output, a movement output, and/or the like. Additionally, or alternatively, the classification label prediction computing entity 106 may include, or be in communication with, one or more other elements.

### B. Example Client Computing Entity

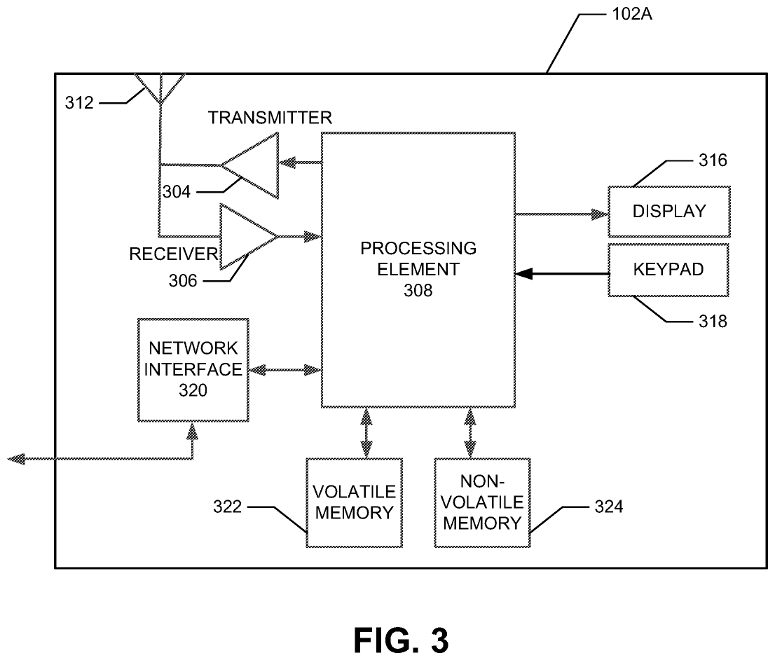

Referring now to FIG. 3, an example illustrative schematic representative of an example client computing entity 102A that can be used in conjunction with embodiments of the present disclosure is illustrated. In some embodiments, client computing entities (such as, but not limited to, the client computing entity 102A, the client computing entity 102B, . . . , the client computing entity 102N) can be operated by various parties.

In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

In some embodiments, the client computing entity 102A comprises an antenna 312, a transmitter 304 (e.g., radio), a receiver 306 (e.g., radio), and a processing element 308, as shown in the example illustrated in FIG. 3. In some embodiments, the processing element 308 may provide signals to and receives signals from the transmitter 304 and receiver 306, correspondingly. In some embodiments, examples of the processing element 308 may include, but are not limited to, CPLDs, microprocessors, multi-core processors, coprocessing entities, ASIPs, microcontrollers, and/or controllers.

In some embodiments, the signals provided to and received from the transmitter 304 and the receiver 306, correspondingly, include signaling information/data in accordance with air interface standards of applicable wireless systems. In some embodiments, the client computing entity 102A may be capable of operating with one or more air interface standards, communication protocols, modulation types, and access types. In some embodiments, the client computing entity 102A may operate in accordance with any of a number of wireless communication standards and protocols associated with one or more other computing entities, such as those described above with regard to the classification label prediction computing entity 106. In some embodiments, the client computing entity 102A may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. In some embodiments, the client computing entity 102A may operate in accordance with multiple wired communication standards and protocols associated with one or more other computing entities (such as those described above with regard to the classification label prediction computing entity 106) via a network interface 320.

In some embodiments, via these communication standards and protocols, the client computing entity 102A communicates with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). In some embodiments, the client computing entity 102A may download changes, add-ons, and updates, for instance, to its firmware, software (e.g., including executable instructions, applications, program modules), and operating system.

In some embodiments, the client computing entity 102A may include location determining aspects, devices, modules, functionalities, and/or similar words used herein interchangeably. In some embodiments, the client computing entity 102A may include outdoor positioning aspects, such as a location module adapted to acquire, for example, latitude, longitude, altitude, geocode, course, direction, heading, speed, universal time (UTC), date, and/or various other information/data. In some embodiments, the location module can acquire data, sometimes known as ephemeris data, by identifying the number of satellites in view and the relative positions of those satellites (e.g., using global positioning systems (GPS)). In some embodiments, the satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. In some embodiments, this data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Additionally, or alternatively, the location information/data can be determined by triangulating the position of the client computing entity 102A in connection with a variety of other systems, including cellular towers, Wi-Fi access points, and/or the like. In some embodiments, the client computing entity 102A may include indoor positioning aspects, such as a location module adapted to acquire, for example, latitude, longitude, altitude, geocode, course, direction, heading, speed, time, date, and/or various other information/data. In some embodiments, some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

In some embodiments, the client computing entity 102A comprises a user interface (that can include a display 316 coupled to a processing element 308) and/or a user input interface (coupled to a processing element 308), as shown in the example illustrated in FIG. 3. In some embodiments, the user interface may be a user application, browser, user interface, and/or similar words used herein interchangeably executing on and/or accessible via the client computing entity 102A to interact with and/or cause display of information/data from the classification label prediction computing entity 106, as described herein. In some embodiments, the user input interface may comprise any of a number of devices or interfaces allowing the client computing entity 102A to receive data, such as a keypad 318 (hard or soft), a touch display, voice/speech or motion interfaces, or other input devices. In embodiments including a keypad 318, the keypad 318 may include (or cause display of) the conventional numeric (0-9) and related keys (#, *), and other keys used for operating the client computing entity 102A and may include a full set of alphabetic keys or set of keys that may be activated to provide a full set of alphanumeric keys. In addition to providing input, the user input interface can be used, for example, to activate or deactivate certain functions, such as screen savers and/or sleep modes.

In some embodiments, the client computing entity 102A may include volatile memory 322 and/or non-volatile memory 324, which can be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. In some embodiments, the volatile and non-volatile memory may store databases, database instances, database management systems, data, applications, programs, program modules, scripts, source code, object code, byte code, compiled code, interpreted code, machine code, executable instructions, and/or the like to implement the functions of the client computing entity 102A. In some embodiments, this may include a user application that is resident on the entity or accessible through a browser or other user interface for communicating with the classification label prediction computing entity 106 and/or one or more other computing entities.

In another embodiment, the client computing entity 102A may include one or more components or functionality that are the same or similar to those of the classification label prediction computing entity 106 as described in greater detail above. As will be recognized, these architectures and descriptions are provided for example purposes only and are not limiting to the various embodiments.

In various embodiments, the client computing entity 102A may be embodied as an artificial intelligence (AI) computing entity, such as an Amazon® Echo, Amazon® Echo Dot, Amazon® Show, Google® Home, Apple® HomePod, and/or the like. Accordingly, the client computing entity 102A may be configured to provide and/or receive information/data from a user via an input/output mechanism such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “data object” refers to a data structure that represents, indicates, stores and/or comprises data and/or information. In some embodiments, a data object may be in the form of one or more regions in one or more data storage devices (such as, but not limited to, a computer-readable storage medium) that comprise and/or are associated with one or more parameters (such as, but not limited to, identifiers, metadata, and/or the like).

In some embodiments, the term “training data object” refers to a type of data object that is used by one or more computing entities (such as, but not limited to, the data object prediction platform/system 101 and/or the classification label prediction computing entity 106 described in connection with at least FIG. 1) for training one or more machine learning models (such as, but not limited to, the anomaly detection machine learning model and/or the classification prediction machine learning model described herein).

In some embodiments, an example training data object represents, indicates, stores and/or comprises data and/or information associated one or more users (such as, but not limited to, patients) of an example data object prediction platform/system in accordance with some embodiments of the present disclosure (such as, but not limited to, the data object prediction platform/system 101 described above in connection with at least FIG. 1). For example, an example training data object may indicate, comprise, represent, and/or be associated with one or more medical records associated with one or more patients.

As an example in the healthcare context, an example training data object may comprise healthcare related data and/or information associated with a user (such as, but not limited to, a patient). For example, an example training data object may be in the form of and/or comprise one or more electronic medical records (“EMRs”) or electronic health records (“EHRs”), which may indicate, comprise, represent, and/or be associated with data and information associated with one or more patients, such as, but not limited to, health statuses or conditions of the one or more patients (for example, any current symptoms that the one or more patients may exhibit or experience, any current medications that the one or more patients may be taking), health histories of the one or more patients (for example, any symptoms that the one or more patients may have exhibited or experienced in the past, any medications that the one or more patients may have taken in the past, any procedures that may have been conducted on the one or more patients, and/or the like), office visits by the one or more patients (for example, data and/or information associated with one or more visits to a doctor's office, a clinic, a pharmacy, a hospital, and/or the like for seeking medical help, medical treatment, medical assistance, pharmacy prescriptions, and/or the like), medical claims associated with the user, and/or the like.

Additionally, or alternatively, an example training data object may comprise demographic data and/or information (such as, but not limited to, age, gender, ethnicity, and/or the like) associated with a user (such as, but not limited to, a patient). Additionally, or alternatively, an example training data object may comprise socioeconomic data and/or information (such as, but not limited to, income level, education level, occupation, and/or the like) associated with a user (such as, but not limited to, a patient). Additionally, or alternatively, an example training data object may comprise other data and/or information.

In some embodiments, the term “labeled training data object” refers to a type of training data object that comprises or is associated with one or more labeled classification parameters. In some embodiments, the term “labeled classification parameter” refers to a parameter or a data field that comprises, indicates, and/or represents one classification label (from among a plurality of classification labels) that is associated with a corresponding training data object. For example, the labeled classification parameter may comprise, indicate, and/or represent a label of interest associated with the training data object.

In some embodiments, an example labeled classification parameter may indicate an anomaly classification label. In some embodiments, the term “anomaly classification label” refers to a type of label for a training data object indicating that the training data object does not conform with the normal and/or typical behavior and/or condition among a plurality of training data objects. For example, the anomaly classification label may indicate that the training data object is associated with or is likely associated with an abnormal and/or atypical condition.

In some embodiments, an example labeled classification parameter may indicate a normal classification label. In some embodiments, the term “normal classification label” refers to a type of label for a training data object indicating that the training data object conforms with the normal and/or typical behavior and/or condition among a plurality of training data objects. For example, the normal classification label may indicate that the training data object is not associated with or is unlikely to be associated with the abnormal and/or atypical condition described above in connection with the anomaly classification label.

In the present disclosure, data and/or information from an example training data object may be represented generally as “x,” and the example labeled classification parameter associated with the example training data object may be represented generally as “Y.”

Continuing from the example in the healthcare context above, an example training data object may comprise data and/or information such as, but not limited to, healthcare related data and/or information, demographic data and/or information, socioeconomic data and/or information, and/or the like associated with a user (such as a patient). Various example embodiments in accordance with the present disclosure may be implemented to detect and/or predict rare disease among the users (such as patients). In such an example, an example labeled classification parameter associated with an example training data object may indicate the (likely) presence or absence of a rare disease in a user (such as a patient) corresponding to the example training data object. For example, the example labeled classification parameter may be in the form of a binary classification that indicates either a normal classification label (which may be represented as “0”) or an anomaly classification label (which may be represented as “1”). If a labeled training data object is associated with a labeled classification parameter that indicates a normal classification label (“0”), the user (such as the patient) associated with the labeled training data object does not have or is unlikely to have the rare disease. If a labeled training data object is associated with a labeled classification parameter that indicates an anomaly classification label (“1”), the user (such as the patient) associated with the labeled training data object has or is likely to have the rare disease.

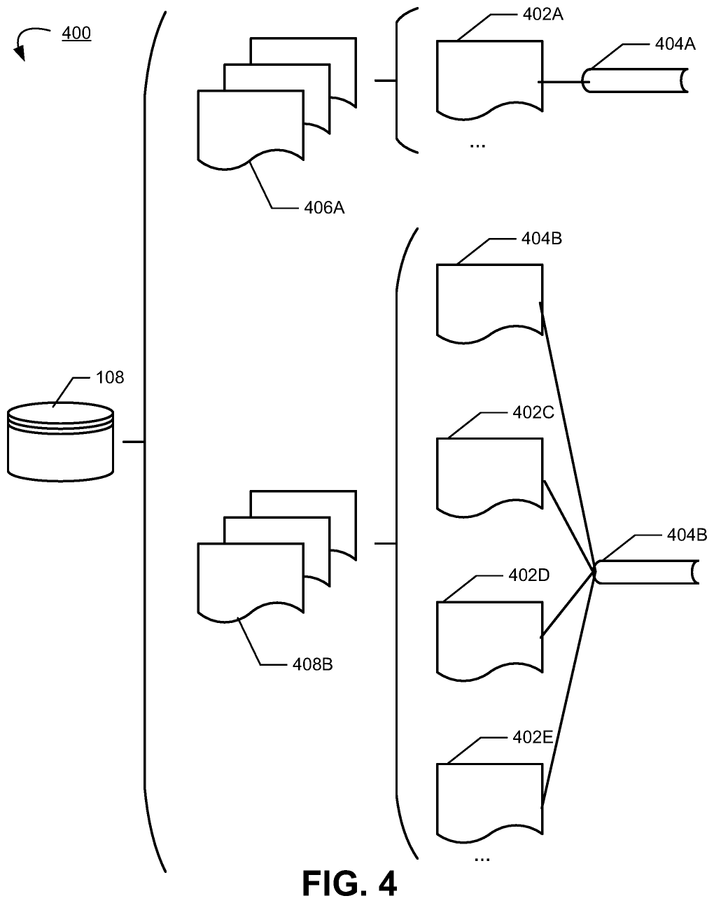

Referring now to FIG. 4, an example diagram 400 illustrates examples of labeled training data objects and examples of labeled classification parameters in accordance with some embodiments of the present disclosure.

In the example shown in FIG. 4, a plurality of labeled training data objects (such as, but not limited to, a labeled training data object 402A, a labeled training data object 402B, a labeled training data object 402C, a labeled training data object 402D, and a labeled training data object 402E) is stored in a data storage device (such as, but not limited to, the training data object storage entity 108 described above in connection with at least FIG. 1). In some embodiments, a labeled training data object of the plurality of labeled training data objects is associated with one of a plurality of labeled classification parameters (such as, but not limited to, the labeled classification parameter 404A or the labeled classification parameter 404B).

In some embodiments, a labeled classification parameter of the plurality of labeled classification parameters indicates at least one of a normal classification label or an anomaly classification label as described above. As an example, the labeled classification parameter 404A may indicate an anomaly classification label, and the labeled classification parameter 404B may indicate a normal classification label.

In some embodiments, the term “anomaly training data object” refers to a training data object that is associated with the anomaly classification label. Continuing from the example above, the collection 406A of anomaly training data objects comprises the labeled training data object 402A, as the labeled training data object 402A is associated with the labeled classification parameter 404A (which indicates anomaly classification label). In some embodiments, the collection 406A of anomaly training data objects may be represented as (x|Y=1).

In some embodiments, the term “normal training data object” refers to a training data object that is associated with the normal classification label. Continuing from the example above, the collection 406B of normal training data objects comprises the labeled training data object 402B, the labeled training data object 402C, the labeled training data object 402D, and the labeled training data object 402E, as they are associated with the labeled classification parameter 404B (which indicates normal classification label). In some embodiments, the collection 406B of normal training data objects may be represented as (x|Y=0).

In some embodiments, the term “anomaly training data object count” refers to a count number of the anomaly training data object(s). In some embodiments, the term “normal training data object count” refers to a count number of the normal training data object(s). In some embodiments, a normal training data object count associated with the plurality of normal training data objects is larger than an anomaly training data object count associated with the plurality of anomaly training data objects.

For example, in the health context example described above, it is likely that there are more users who do not have a rare disease condition (e.g., training data objects associated with the normal classification label) than users who has the rare disease condition (e.g., training data objects associated with the anomaly classification label). However, if training data objects associated with one of the classification labels are scarce relative to the other classification label(s), the training data objects may be described as “imbalanced,” which may lead to classification/prediction inaccuracy by machine learning models that are trained using the imbalanced training data objects (particularly with respect to labeling of the scarce classification labels described above). Various embodiments of the present disclosure overcome these technical challenges and difficulties while improving prediction accuracy based on training the anomaly detection machine learning model based on a composite loss parameter, details of which are described herein.

While the description above provides an example of the labeled classification parameter providing a binary classification, it is noted that the scope of the present disclosure is not limited to the description above. In some examples, an example labeled classification parameter may indicate a classification label that is selected from more than two types of classification labels. Continuing from the example in the healthcare context above, the example labeled classification parameter indicates one of a first classification label (indicating, for example, the user associated with the training data object does not have any diabetic health condition), a second classification label (indicating, for example, the user associated with the training data object has Type 1 diabetes), and a third classification label (indicating, for example, the user associated with the training data object has Type 2 diabetes). As such, while various examples of the present disclosure describe a single normal class (Y=0), there is no limit in the number of anomaly types. For example, Y=1, Y=2, Y=3 may correspond to three categories of patients that various example machine learning models may discriminate from the normal class.

In some embodiments, the terms “anomaly detection machine learning model” or “anomaly prediction machine learning model” refer to a type of machine learning model that generates predictions on whether a data object (such as, but not limited to, a training data object) is associated with an anomaly classification label. In some embodiments, an example anomaly detection machine learning model may be in the form of or comprise an artificial neural network. Examples of artificial neural networks may include, but are not limited to, autoencoders, recurrent neural networks (RNNs), convolutional neural networks (CNNs), generative adversarial networks (GANs), and/or the like.

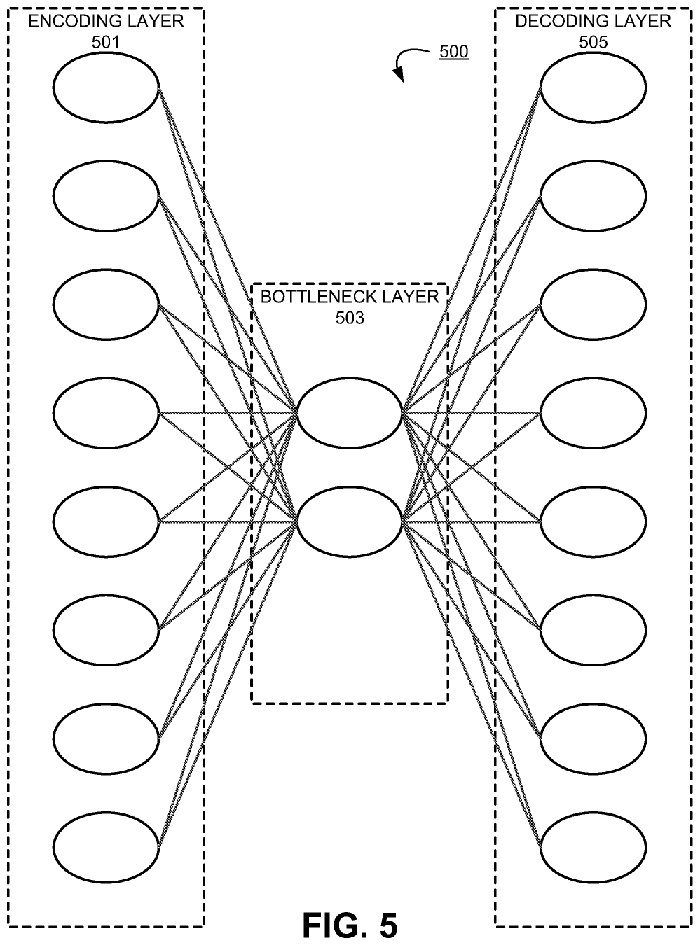

Referring now to FIG. 5, an operational example of an anomaly detection machine learning model in accordance with some embodiments discussed herein is illustrated. In the example shown in FIG. 5, the anomaly detection machine learning model comprises an autoencoder 500.

In some embodiments, the anomaly detection machine learning model comprises a plurality of interconnected artificial neurons. In some embodiments, each artificial neuron represents a mathematical function that is a part of the anomaly detection machine learning model. In some embodiments, the input to an artificial neuron may include one or more input values, and the mathematical function of the artificial neuron may map the one or more input values to one or more output values based on the one or more weight values associated with the one or more input values and/or the artificial neuron.

In some embodiments, artificial neurons are aggregated into one or more neural network layers, and different neural network layers may perform different transformations of their corresponding inputs. In some embodiments, a connection between an artificial neuron in a neural network layer and another artificial neuron in the next neural network layer represents a connection from the output of the artificial neuron to the input of the other artificial neuron in the next neural network layer.

For example, the anomaly detection machine learning model in the example shown in FIG. 5 comprises one or more encoding layers (such as, but not limited to, the encoding layer 501) and one or more decoding layers (such as, but not limited to, the decoding layer 505). In some embodiments, the anomaly detection machine learning model comprises one or more bottleneck layers (such as, but not limited to, the bottleneck layer 503 in the example shown in FIG. 5). In the example shown in FIG. 5, the one or more encoding layers (such as, but not limited to, the encoding layer 501) is followed by the one or more bottleneck layers (such as, but not limited to, the bottleneck layer 503), which is followed by the one or more decoding layers (such as, but not limited to, the decoding layer 505).

In some embodiments, the term “encoding layer” refers to a neural network layer of artificial neurons that encode data provided to the anomaly detection machine learning model. In some embodiments, the encoding layer of the anomaly detection machine learning model may compress the input data into an encoded representation that is orders of magnitude smaller than the input data. For example, the encoding layer 501 may encode one or more data objects (such as, but not limited to, one or more labeled training data objects). In such an example, the one or more encoding layers of the anomaly detection machine learning model may generate encoded training data objects.

In some embodiments, the term “encoded anomaly training data object” refers to a type of anomaly training data object that is encoded by one or more encoding layers of the anomaly detection machine learning model. In some embodiments, the term “encoded normal training data object” refers to a type of normal training data object that is encoded by one or more encoding layers of the anomaly detection machine learning model.

In some embodiments, the bottleneck layer of the anomaly detection machine learning model reduces the dimensionality of encoded data objects from the encoding layers. For example, the bottleneck layer of the anomaly detection machine learning model may further compress the encoded representations to discard irreverent data and/or information. In some embodiments, the number of artificial neurons in each of the bottleneck layers is less than the number of artificial neurons in each encoding layer and is less than the number of artificial neurons in each decoding layer.

In some embodiments, the term “decoding layer” refers to a neural network layer of artificial neurons that decode data that is received from the previous neural network layer of the anomaly detection machine learning model. In some embodiments, the decoding layer of the anomaly detection machine learning model may decompress and reconstruct data back from its decoded form. For example, the decoding layer 505 may decode one or more encoded training data objects that are received from the encoding layer 501 and/or the bottleneck layer 503. In such an example, the one or more decoding layers of the anomaly detection machine learning model may determine, generate, and/or similar words used herein interchangeably reconstructed training data objects. In some embodiments, the number of artificial neurons in the encoding layer is the same as the number of artificial neurons in the decoding layer.

In some embodiments, the term “reconstructed anomaly training data object” refers to a type of training data object that has been reconstructed by one or more decoding layers of the anomaly detection machine learning model based on decoding an encoded anomaly training data object. In some embodiments, the term “reconstructed normal training data object” refers to a type of training data object that has been reconstructed by one or more decoding layers of the anomaly detection machine learning model based on decoding an encoded normal training data object.

As illustrated in the example above, an example anomaly detection machine learning model in the form of an autoencoder provides a neural network architecture that combines layers for encoding and decoding of data. For example, the encoding layer converts an input (for example, but not limited to, a labeled training data object) into a code (for example, the encoded anomaly training data objects and/or the encoded normal training data objects), which is much smaller than the initial input. Continuing in this example, the decoding layer reconstructs the initial input as accurately as possible and generates outputs (for example, the reconstructed anomaly training data objects and/or the reconstructed normal training data objects) using the code as its input.

In some embodiments, the terms “reconstruction loss measure,” “prediction loss measure,” or “autoencoder loss” refer to the difference between the initial inputs (for example, the anomaly training data objects and/or the normal training data objects) and the reconstructed outputs (for example, the reconstructed anomaly training data objects and/or the reconstructed normal training data objects).

In some embodiments, the anomaly detection machine learning model may generate predictions on whether a data object (such as, but not limited to, a training data object) is associated with an anomaly classification label based on the reconstruction loss measures. For example, the anomaly detection machine learning model may generate a prediction that a data object is associated with the anomaly classification label if the reconstruction loss measure associated with reconstruing the data object is higher than loss measures associated with reconstruing other data objects.

In some embodiments, the reconstruction/prediction loss measure comprises anomaly prediction loss parameter(s) and normal prediction loss parameter(s).

In some embodiments, the term “anomaly prediction loss parameter” refers to a reconstruction loss measure associated with the anomaly detection machine learning model in reconstructing a plurality of anomaly training data objects (from a plurality of labeled training data objects) that is associated with the anomaly classification label. For example, the anomaly prediction loss parameter may indicate the difference level between the anomaly training data objects and the reconstructed anomaly training data objects.

In some embodiments, the term “normal prediction loss parameter” refers to a reconstruction loss measure associated with the anomaly detection machine learning model in reconstructing a plurality of normal training data objects (from the plurality of labeled training data objects) that is associated with the normal classification label. For example, the normal prediction loss parameter may indicate the difference level between the normal training data objects and the reconstructed normal training data objects.

While the description above provides an example of an anomaly detection machine learning model in the form of an autoencoder, it is noted that the scope of the present disclosure is not limited to the description above. In some examples, an example anomaly detection machine learning model may comprise one or more additional and/or alternative machine learning models.

In some embodiments, the term “classification prediction machine learning model” refers to a type of machine learning model that generates predictions on labeled classification parameters associated with data objects (such as, but not limited to, labeled training data objects). In some embodiments, an example classification prediction machine learning model may be in the form of or comprise a classifier. In some embodiments, the classifier may comprise one or more artificial neural networks such as, but not limited to, recurrent neural networks (RNNs), convolutional neural networks (CNNs), generative adversarial networks (GANs), and/or the like.

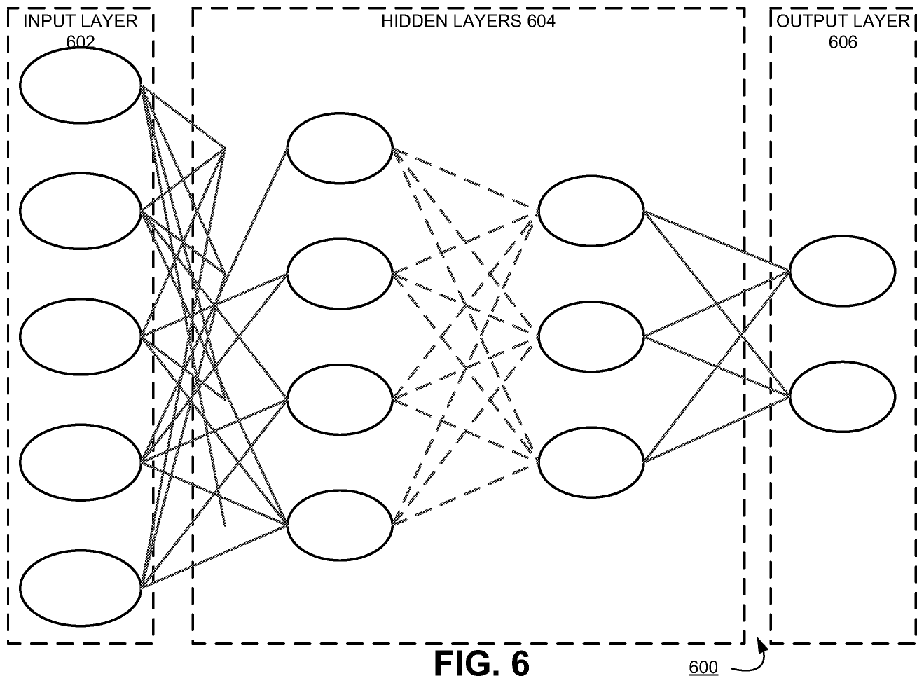

Referring now to FIG. 6, an operational example of a classification prediction machine learning model in accordance with some embodiments discussed herein is illustrated. In the example shown in FIG. 6, the classification prediction machine learning model comprises an artificial neural network 600.

In some embodiments, the classification prediction machine learning model comprises a plurality of interconnected artificial neurons. In some embodiments, each artificial neuron represents a mathematical function that is a part of the classification prediction machine learning model. In some embodiments, the input to an artificial neuron may include one or more input values, and the mathematical function of the artificial neuron may map the one or more input values to one or more output values based on one or more weight values associated with the one or more input values and/or the artificial neuron.

In some embodiments, artificial neurons are aggregated into one or more neural network layers, and different neural network layers may perform different transformations of their corresponding inputs. In some embodiments, a connection between an artificial neuron in a neural network layer and another artificial neuron in the next neural network layer represents a connection from the output of the artificial neuron to the input of the other artificial neuron in the next neural network layer.

For example, the classification prediction machine learning model shown in FIG. 6 comprises one or more input layers (such as, but not limited to, the input layer 602) and one or more output layers (such as, but not limited to, the output layer 606). In some embodiments, the classification prediction machine learning model comprises one or more hidden layers (such as, but not limited to, the hidden layer 604 in the example shown in FIG. 6). In the example shown in FIG. 6, the one or more input layers (such as, but not limited to, the input layer 602) are followed by one or more hidden layers (such as, but not limited to, the hidden layer 604), which are followed by one or more output layers (such as, but not limited to, the output layer 606).

In some embodiments, the term “input layer” refers to a neural network layer of artificial neurons that receives data provided to the classification prediction machine learning model. As an example, the input layer 602 of the classification prediction machine learning model may receive labeled training data objects that are provided to the classification prediction machine learning model (and, in some embodiments, tougher with the normal prediction loss parameter and the anomaly prediction loss parameter), details of which are described herein.

In some embodiments, the hidden layers 604 receive the input data through the input layer 602 and process the input data to generate predictions. For example, the hidden layers 604 may apply weight values on the data received from the previous neural network layer, implement functions (for example, but not limited to, non-linear functions, logical functions, and/or the like) on the data received from the previous neural network layer, and/or transform the data received from the previous neural network layer. Continuing from the labeled training data object example above, the hidden layers 604 may analyze the labeled training data objects (and, in some embodiments, tougher with the normal prediction loss parameter and the anomaly prediction loss parameter) to predict classification labels associated with the training data objects, details of which are described herein.

In some embodiments, the term “output layer” refers to a neural network layer of artificial neurons that outputs predictive data from the classification prediction machine learning model. Continuing from the labeled training data object example above, the output layer of the classification prediction machine learning model may output predicted classification parameters associated with the labeled training data objects. In some embodiments, the term “predicted classification parameter” refers to a parameter that is generated by a classification prediction machine learning model and indicates a prediction of the classification label associated with a training data object.

In some embodiments, the term “global classification loss parameter” refers to a loss measure associated with the classification prediction machine learning model in generating predictions. In some embodiments, the global classification loss parameter may indicate a loss measure associated with the classification prediction machine learning model in predicting the plurality of labeled classification parameters associated with the plurality of labeled training data objects. For example, the global classification loss parameter indicates a difference level between the labeled classification parameters and the predicted classification parameters associated with the plurality of labeled training data objects.

In some embodiments, the term “composite loss parameter” refers to a weighted combination of the normal prediction loss parameter and the global classification loss parameter. For example, the composite loss parameter may be calculated based on the normal prediction loss parameter, the global classification loss parameter, the normal prediction weight parameter, and the global classification weight parameter. In some embodiments, the term “global classification weight parameter” refers to a weight parameter associated with the global classification loss parameter. In some embodiments, the term “normal prediction weight parameter” refers to a weight parameter associated with the normal prediction loss parameter. In some embodiments, the global classification weight parameter and/or the normal prediction weight parameter may be in the form of hyperparameters that can be optimized during training.

In some embodiments, the term “composite loss parameter threshold” refers to a threshold value associated with the composite loss parameter for training the anomaly detection machine learning model. For example, if the composite loss parameter does not satisfy the composite loss parameter threshold, the anomaly detection machine learning model may generate inaccurate or unreliable predictions such that the anomaly detection machine learning model needs further training. If the composite loss parameter does not satisfy the composite loss parameter threshold, the anomaly detection machine learning model may generate accurate and reliable predictions such that the anomaly detection machine learning model does not need further training.

In some embodiments, the term “machine learning model parameter” refers to a parameter, a value, a data field, and/or the like associated with a machine learning model. Examples of machine learning model parameters may include, but are not limited to, a configuration variable, a module setting, a weight value, a hyperparameter, and/or the like. In some embodiments, machine learning model parameters associated with machine learning models may be adjusted and/or optimized through training, details of which are described herein.

In some embodiments, the term “prediction-based operation” refers to one or more computer-implemented operations that are performed based on one or more predictions generated by one or more machine learning models. For example, an example prediction-based operation may include training the machine learning model, especially when the predictions are not accurate or reliable. Additionally, or alternatively, examples of prediction-based operations may include, but are not limited to, generating one or more diagnostic reports based on predictions generated by one or more machine learning models, displaying/providing one or more resources based on the predictions generated by one or more machine learning models, generating one or more action scripts based on predictions generated by one or more machine learning models, and/or generating alerts or reminders based on the predictions generated by one or more machine learning models.

### IV. OVERVIEW, TECHNICAL IMPROVEMENTS, AND TECHNICAL ADVANTAGES

There are many technical challenges and difficulties associated with machine learning models. For example, many machine learning models generate inaccurate and unreliable predictions due to training based on imbalanced training data (such as, but not limited to, class-imbalanced training datasets). In the present disclosure, the term “class-imbalanced training dataset” refers to a dataset of training data objects for training machine learning models where the total numbers of training data objects associated with different classification labels differ significantly.

As an example in the healthcare context, machine learning models are hampered in their ability to identify rare diseases among patients because there are relatively fewer numbers of patients who have been diagnosed with the rare disease compared to the numbers of patients who have not been diagnosed with the rare disease. In particular, a rare (or “inherited”) disease is generally defined as one that is found in less than 1 in 2,000 people. While training data for identifying diseases may be generated based on sampling and/or surveying data among the general population, the 1:2000 ratio in rare diseases results in a class-imbalanced training dataset that has significantly less data associated with people who has the rare disease as compared to data associated with people who does not have the rare disease. As a result, after machine learning models are trained based on such class-imbalanced training dataset, the machine learning models may be unable to recognize data patterns from the class-imbalanced training dataset that are associated with the occurrence of the rare disease, and/or may generate incorrect predictions indicating that a patient does not have a rare disease. As such, many machine learning models are not able to generate accurate and reliable predictions on rare disease occurrences.

Such technical challenges and difficulties have additional implications. Continuing from the example in the healthcare context above, rare diseases cost the healthcare system in the United States nearly one trillion dollars annually. In particular, rare diseases are often incorrectly diagnosed, leading to inappropriate treatments and care associated with managing the improperly treated disease. According to a survey from 2013, it takes an average of more than five years, eight physicians, and two to three misdiagnoses until a rare disease patient receives the correct diagnosis. The succession of incorrect or absent diagnoses that eventually leads to a correct diagnosis is often referred to as a “diagnostic odyssey.” Rare diseases incur direct costs to the healthcare system in the United States of over four hundred billion dollars annually and non-medical costs of more than five hundred billion dollars for a combined cost of nearly one trillion dollars. Such as, health insurance payors, healthcare providers, and patients would greatly benefit from early and accurate identification of individuals with a rare disease to reduce the duration of diagnostic odysseys and their associated suffering and expense. One of the first steps to early identification is to identify patients who have a high likelihood of having a rare disease based on existing medical data and, in some examples, such medical data does not include tests (e.g., genetic screening) designed to identify specific rare diseases.

Identifying such high likelihood patients can help to allocate costly, disease-specific tests efficiently. However, each rare disease patient's “diagnostic odyssey” is reflected in high levels of misdiagnoses and stochasticity in their medical records, which may pose challenges and difficulties in training machine learning models based on such data. Some methods may attempt to address such technical challenges and difficulties by generating synthetic training data to augment underpopulated data classes. However, generation of synthetic data that improves classification performance on real-world (non-synthetic) data often proves to be technically difficult.

Various embodiments of the present disclosure overcome these technical challenges and difficulties and provide various technical improvements and advantages. For example, various embodiments of the present disclosure overcome the technical challenges and difficulties associated with class-imbalanced training dataset and provide technical contributions to improving predictive accuracy and reliability by implementing an anomaly detection machine learning model (such as, but not limited to, an autoencoder) and a classification prediction machine learning model (such as, but not limited to, a classifier). In such an example, the combination of the anomaly detection machine learning model and the classification prediction machine learning model overcomes technical shortcomings associated with each machine learning model alone and improves efficiency, accuracy and reliability in training machine learning models to detect anomaly.

On one hand, the encoding layers and the decoding layers in some autoencoders are each trained to minimize the reconstruction loss measure of only the autoencoders and maximize the ability of the autoencoders to reconstruct the original input received by the autoencoders. Such autoencoders may excel in detecting data anomalies and deviations from a norm in the dataset (such as a succession of incorrect or absent diagnoses from healthcare data associated with a patient), but alone they may struggle to model the specific type of errors observed from the dataset (for example, rare disease of patients).

On the other hand, the classifier may generate predictions based on supervised learning techniques, which can be utilized to model the differences between a normal class (for example, patients without a given condition such as a rare disease) and a specific, abnormal group (for example, rare disease carriers or patients with a given condition such as the rare disease). However, the predictions from the classifier generally rely on well-defined differences between classes (which does not encompass, for example, the stochasticity of wrong or missing diagnoses in the healthcare related data), and the classifier tends to perform poorly when trained with class-imbalanced training dataset classes as described above.

In contrast, by combining anomaly detection machine learning models (such as an example autoencoder that may function as an anomaly detector) and classification prediction machine learning models (such as an example classifier) through feedback loops, various embodiments of the present disclosure model utilize both the stochastic and deterministic parts of the training data objects (for example, a patient's medical history) to detect anomaly (for example, early identification of at-risk individuals).

For example, various embodiments of the present disclosure improves the accuracy and reliability of predictions on anomaly conditions based on training the anomaly detection machine learning model based on a composite loss parameter that is a weighted combination of the normal prediction loss parameter associated with the anomaly detection machine learning model and the global classification loss parameter associated with a classification prediction machine learning model.

As such, various embodiments of the present disclosure provide improved predictive performance metrics (such as, but not limited to, accuracy, reliability, and/or the like) for classification tasks involving imbalanced data classes. The techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

While some example embodiments of the present disclosure are described to highlight improved prediction of rare disease, it is noted that the scope of the present disclosure is not limited to rare disease prediction. For example, various embodiments of the present disclosure may improve the prediction performance, accuracy, and reliability in any circumstance with class-imbalanced training dataset, and may improve the prediction performance, accuracy, and reliability in situations where the training dataset are associated with well-balanced classes.

### V. EXAMPLE SYSTEM OPERATIONS

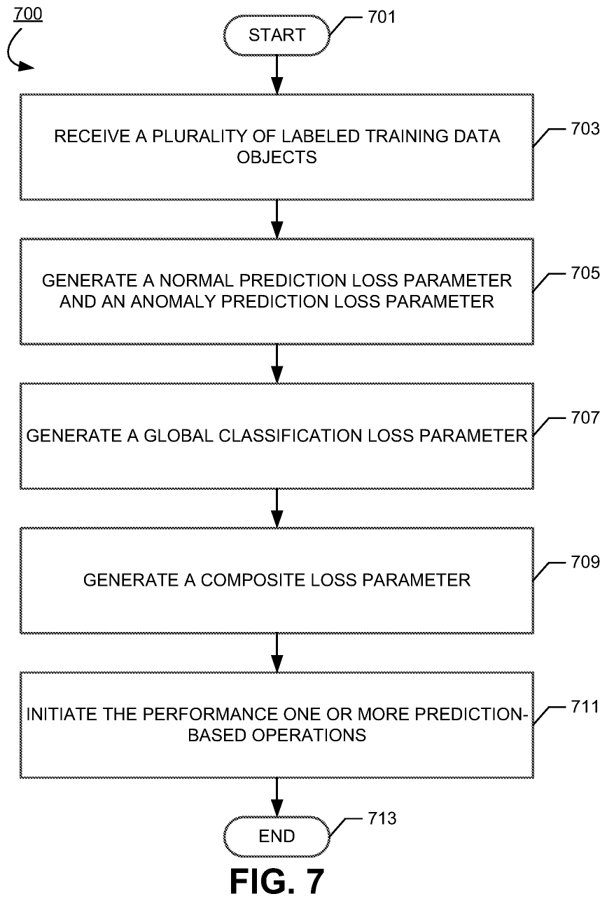

As described above, there are technical challenges, deficiencies, and problems associated with machine learning models, and various example embodiments of the present disclosure overcome such technical challenges, deficiencies, and problems. For example, FIG. 7 illustrates an example flowchart diagram of an example method 700 for optimizing anomaly detection by an example anomaly detection machine learning model in accordance with some embodiments discussed herein.

For example, the example method 700 may improve the accuracy and reliability of machine learning model generated predictions by determining a normal prediction loss parameter and an anomaly prediction loss parameter, determining a global classification loss parameter, and determining a composite loss parameter. In some embodiments, by training the anomaly detection machine learning model based on the composite loss parameter, various embodiments of the present disclosure overcome technical challenges and difficulties associated with training machine learning models based on class-imbalanced dataset.

As shown in FIG. 7, the example method 700 starts at step/operation 701. Subsequent to and/or in response to step/operation 701, the example method 700 proceeds to step/operation 703. At step/operation 703, a computing entity (such as, but not limited to, the classification label prediction computing entity 106 described above in connection with FIG. 1 and FIG. 2 and/or the client computing entity 102A described above in connection with FIG. 1 and FIG. 3) receives a plurality of labeled training data objects.

In some embodiments, the plurality of labeled training data objects is received or retrieved from a data storage device (such as, but not limited to, the training data object storage entity 108 described in connection with FIG. 1). In some embodiments, a labeled training data object of the plurality of labeled training data objects is associated with one of a plurality of labeled classification parameters. In some embodiments, a labeled classification parameter of the plurality of labeled classification parameters indicates at least one of a normal classification label or an anomaly classification label.

Continuing from the healthcare example described above, the normal classification label may indicate that the user (such as patient) associated with the labeled training data object does not have or is unlikely to have the rare disease, and the anomaly classification label may indicate that the user (such as patient) associated with the labeled training data object has or is likely to have the rare disease. In such an example, the inputs to the anomaly detection machine learning model and the classification prediction machine learning model include training data for both individuals with rare disease (“x|Y=1”) and those without a rare disease (“x|Y=0”).

In some embodiments, the example method 700 optionally comprises selecting a plurality of normal training data objects and a plurality of anomaly training data objects from the plurality of labeled training data objects (rather than utilizing the entirety of the labeled training data objects) so as to improve the predictive performance of the machine learning models. As described above, each of the plurality of normal training data objects (“x|Y=0”) is associated with the normal classification label, and each of the plurality of anomaly training data objects (“x|Y=1”) is associated with the anomaly classification label.

For example, in some embodiments, the example method 700 implements one or algorithms (such as, but not limited to, Hamming distance algorithms, Levenshtein distance algorithms, and/or the like) and/or machine learning models (such as, but not limited to, artificial neural networks such as RNNs, CNNs, and GANs) to identify labeled training data objects that are similar to one another without the labeled classification parameters. In particular, training machine learning models based on similar labeled training data objects may improve the predictive performance of the machine learning models. Continuing from the healthcare example above, the example method 700 may select labeled training data objects that have similar demographic data and/or information, socioeconomic data and/or information, and/or the like except for the presence or absence of the rare disease diagnosis. While the description above provides an example method of selecting similar training data objects, it is noted that the scope of the present disclosure is not limited to the description above.

Additionally, or alternatively, in some embodiments, the example method 700 comprises selecting labeled training data objects based at least in part a normal training data object count associated with the plurality of normal training data objects and an anomaly training data object count associated with the plurality of anomaly training data objects. As described above, in some embodiments, the normal training data object count may be larger than an anomaly training data object count, causing the technical effect of a class-imbalanced training dataset.

Various embodiments of the present disclosure may further improve the predictive performance (such as, but not limited to, the accuracy and/or the reliability) of the machine learning models by setting a ratio between the normal training data object count and the anomaly training data object count to 4:1. In particular, the 4:1 ratio provides technical improvements on the accuracy of the machine learning models in detecting anomaly data. Continuing from the healthcare example above, each individual who has been diagnosed with a rare disease is matched to four other individuals who have not been diagnosed with the rare disease.

In some embodiments, when selecting a cohort of labeled training data objects, the 4:1 ratio is combined with algorithms and/or machine learning models to identify similar labeled training data objects. Continuing from the healthcare example above, for every individual for whom Y=1, four individuals are selected for whom Y=0, and all x values among the Y=0 individuals and the Y=1 individual are as similar as possible. As described in detail herein, the machine learning models are trained to collectively distinguish individuals with the rare disease diagnosis from the combined group of matched individuals, and training the machine learning models on this selected, matched cohort improves their performance as compared to training on the general population (even when predicting classifications of members of the general population that do not have the rare disease). While the description above provides an example ratio between the normal training data object count and the anomaly training data object count, it is noted that the scope of the present disclosure is not limited to the description above.

Referring back to FIG. 7, subsequent to and/or in response to step/operation 703, the example method 700 proceeds to step/operation 705. At step/operation 705, a computing entity (such as, but not limited to, the classification label prediction computing entity 106 described above in connection with FIG. 1 and FIG. 2 and/or the client computing entity 102A described above in connection with FIG. 1 and FIG. 3) generates a normal prediction loss parameter and an anomaly prediction loss parameter.

In some embodiments, the normal prediction loss parameter and the anomaly prediction loss parameter are determined based on inputting the plurality of labeled training data objects to an anomaly detection machine learning model. In some embodiments, the normal prediction loss parameter is associated with the normal classification label and indicates a reconstruction loss measure associated with the anomaly detection machine learning model in reconstructing a plurality of normal training data objects. In some embodiments, the anomaly prediction loss parameter is associated with the anomaly classification label and indicates a reconstruction loss measure associated with the anomaly detection machine learning model in reconstructing a plurality of anomaly training data objects.

For example, the anomaly detection machine learning model may comprise an autoencoder. Similar to those described above, the autoencoder may be initially trained to reconstruct the inputs described above (for example, normal training data objects (x|Y=0) and anomaly training data objects (x|Y=1)). In some embodiments, the autoencoder may comprise one or more encoding layers and decoding layers.

Continuing from the healthcare example above, the one or more encoding layers may convert the inputs into a code. Using the code as its input, the one or more decoding layers may reconstruct the original data (x) from patients with a rare disease (Y=1) and those control patients who do not have the rare disease (Y=0) and may initially be optimized to do a better code reconstruction for the control patients than for patients with rare disease. In such an example, the autoencoder yields at least two outputs:
(a) a normal prediction loss parameter ( [symbol] _{AE}(x,\hat{x})|Y=0) that represents a loss for instances (from the matched cohort) in which the patient has no rare disease; and
(b) an anomaly prediction loss parameter ( [symbol] _{AE}(x,\hat{x})|Y=1) that represents a loss for instances (from the matched cohort) in which the patient has a rare disease.

While the description above provides an example of binary classification, it is noted that the scope of the present disclosure is not limited to the description above. In some examples, an example labeled classification parameter may indicate a classification label that is selected from more than two types of classification labels. In such an example, the anomaly detection machine learning model (such as, but not limited to, an autoencoder) may determine, generate, and/or similar words used herein interchangeably a prediction loss parameter for each type of classification label.

Referring back to FIG. 7, subsequent to and/or in response to step/operation 705, the example method 700 proceeds to step/operation 707. At step/operation 707, a computing entity (such as, but not limited to, the classification label prediction computing entity 106 described above in connection with FIG. 1 and FIG. 2 and/or the client computing entity 102A described above in connection with FIG. 1 and FIG. 3) generates a global classification loss parameter.

In some embodiments, the global classification loss parameter is determined based on inputting the plurality of labeled training data objects received at step/operation 703, the normal prediction loss parameter determined at step/operation 705, and the anomaly prediction loss parameter determined at step/operation 705 to a classification prediction machine learning model.

In some embodiments, the classification prediction machine learning model comprises a classifier (for example, an artificial neural network such as, but not limited to, RNNs, CNNs, and/or the like). For example, the classifier may predict labeled classification parameters (Y) associated with the plurality of labeled training data objects received at step/operation 703 based on the normal prediction loss parameter determined at step/operation 705 and the anomaly prediction loss parameter determined at step/operation 705.

Continuing from the healthcare example, the inputs to the classifier include:
(a) anomaly training data objects (x|Y=1) that represent labeled input data for individuals (from the matched cohort) with rare disease;
(b) normal training data objects (x|Y=0) that represent labeled input data for individuals (from the matched cohort) without a rare disease;
(c) the normal prediction loss parameter ( [symbol] _{AE}(x,\hat{x})|Y=0) that represents the autoencoder loss for instances in which the patient (from the matched cohort) has no rare disease; and
(d) the anomaly prediction loss parameter ( [symbol] _{AE}(x,\hat{x})|Y=1) that represents autoencoder loss for instances in which the patient (from the matched cohort) has a rare disease.

In some embodiments, the classifier yields a global classification loss parameter (L_{CLF}) that includes the classifier loss with respect to Y. In some embodiments, the global classification loss parameter may be defined as follows:

L_{CLF}= [symbol] _{CLF}((x, [symbol] _{AE}(x,\hat{x})),Y).

In the above example, the expression refers to a classifier that reads x and [symbol] _{AE}(x,\hat{x}).

While the description above provides an example form of the global classification loss parameter, it is noted that the scope of the present disclosure is not limited to the description above. In some examples, an example global classification loss parameter may be defined as follows:

L_{CLF}= [symbol] _{CLF}((c,x, [symbol] _{AE}(x,\hat{x})),Y)

In the above example, the classifier reads information along with x (which is denoted as “c, x” for covariates and training data) or different from x (which is denoted as “c” for covariates).

In some embodiments, an example global classification loss parameter may be in other forms.

In some embodiments, the classifier is trained and optimized to minimize the global classification loss parameter.

While the description above provides an example of binary classification, it is noted that the scope of the present disclosure is not limited to the description above. In some examples, an example labeled classification parameter may indicate one classification label that is selected from more than two types of classification labels. In such an example, the inputs to the classifier include the autoencoder loss associated with each classification label. As described above, the example labeled classification parameter indicates one of a first classification label (indicating, for example, the user associated with the training data object does not have any diabetic health condition), a second classification label (indicating, for example, the user associated with the training data object has Type 1 diabetes), and a third classification label (indicating, for example, the user associated with the training data object has Type 2 diabetes). While various examples of the present disclosure describe a single normal class (Y=0), there is no limit in the number of anomaly types. For example, Y=1, Y=2, Y=3 may correspond to three categories of patients that various example machine learning models may discriminate from the normal class. Further, while the description above provides an example of a classifier for the classification prediction machine learning model in the form of an artificial neural network, it is noted that the scope of the present disclosure is not limited to the description above. In some examples, an example classification prediction machine learning model may comprise one or more additional and/or alternative types of machine learning models.

Referring back to FIG. 7, subsequent to and/or in response to step/operation 707, the example method 700 proceeds to step/operation 709. At step/operation 709, a computing entity (such as, but not limited to, the classification label prediction computing entity 106 described above in connection with FIG. 1 and FIG. 2 and/or the client computing entity 102A described above in connection with FIG. 1 and FIG. 3) generates a composite loss parameter. In some embodiments, the composite loss parameter represents a loss measure that is computed using both the reconstruction loss from the anomaly detection machine learning model (for example, an autoencoder) and the classification loss from the classification prediction machine learning model (for example, a classifier).

In some embodiments, the composite loss parameter is determined based on the normal prediction loss parameter determined at step/operation 705, the global classification loss parameter determined at step/operation 707, a normal prediction weight parameter, and a global classification weight parameter. In some embodiments, the composite loss parameter comprises a weighted combination of the normal prediction loss parameter and the global classification loss parameter based on the normal prediction weight parameter and the global classification weight parameter. For example, the composite loss parameter may be calculated based on optimizing a weighted combination of a first weight of the normal prediction loss parameter (e.g., the autoencoder loss) and a second weight of the global classification weight parameter (e.g., the classification loss) to ultimately minimize the classification loss. In some embodiments, the composite loss parameter L_{AE_comp} may be calculated based on the following:

$${L}_{AE\_comp} = α [ {ℒ}_{A E} ( x , \hat{x} ) \vert Y = 0 ] + β [ {L}_{C L F} ]$$

In the above example, [symbol] _{AE}(x,\hat{x})|Y=0 represents the normal prediction loss parameter, L_{CLF} represents the global classification loss parameter, α represents the normal prediction weight parameter, and β represents the global classification weight parameter. In some embodiments, the normal prediction weight parameter α may be zero or a number approaching zero. In some embodiments, the composite loss parameter L_{AE_comp} is defined where α and β are hyperparameters that can be adjusted and/or optimized during training.

While the description above provides an example calculation of the composite loss parameter, it is noted that the scope of the present disclosure is not limited to the description above. For example, an example composite loss parameter may be calculated based on a weighted combination of the global classification loss parameter and the anomaly prediction loss parameter (in addition to or in alternative of the normal prediction loss parameter).

Referring back to FIG. 7, subsequent to and/or in response to step/operation 709, the example method 700 proceeds to step/operation 711. At step/operation 711, a computing entity (such as, but not limited to, the classification label prediction computing entity 106 described above in connection with FIG. 1 and FIG. 2 and/or the client computing entity 102A described above in connection with FIG. 1 and FIG. 3) initiate the performance of one or more prediction-based operations.

In some embodiments, performing the one or more prediction-based operations is based on the anomaly detection machine learning model and the composite loss parameter determined at step/operation 709. In some embodiments, the example method 700 utilizes back propagation techniques to optimize the parameters of the anomaly detection machine learning model (for example, an autoencoder) to minimize the composite loss parameter determined at step/operation 709. In some embodiments, through training the anomaly detection machine learning model based on the composite loss parameter determined at step/operation 709, various embodiments of the present disclosure provide a classification label prediction system (for example, hosted by the classification label prediction computing entity 106 described above) including the anomaly detection machine learning model and the classification prediction machine learning model that, in combination, provide optimized predictions on the classification label (Y) associated with data objects, providing improved accuracy and reliability in generating predictions.

For example, TABLE 1 below illustrates comparisons of predictive performances between a zero-rule baseline that always predicts the most frequent classification label in the dataset, (2) a classification prediction machine learning model (such as a classifier) alone, and (3) a classification prediction machine learning model (such as a classifier) working in combination with an anomaly detection machine learning model (such as the autoencoder) that is trained only on composite loss parameters described herein.

TABLE 1
PREDICTIVE PERFORMANCE COMPARISON

| Predictive | Zero- | Classification | Anomaly detection Machine Learning |
|---|---|---|---|
| Performance | Rule | Prediction Machine | Model Combined with Classification |
| Measure | Baseline | Learning Model Alone | Prediction Machine Learning Model |
| AUROC class 0 | 0.5 | 0.64 | 0.65 |
| AUROC class 1 | 0.5 | 0.64 | 0.65 |
| AUPRC class 0 | 0.796 | 0.865 | 0.876 |
| AUPRC class 1 | 0.204 | 0.311 | 0.321 |

As illustrated in TABLE 1 above, the anomaly detection machine learning model combined with the classification prediction machine learning model provide improvements in predictive performance measures on predicting classification labels. As demonstrated, the combination trained with composite loss parameters performs classification predictions more accurately than a zero-rule baseline (which always predicts the most frequent class (here, Y=0)) and the classification prediction machine learning model alone. Such improvements are results of training the anomaly detection machine learning model (such as the autoencoder) to minimize a composite loss parameter, which is calculated using both the loss of the anomaly detection machine learning model (such as an autoencoder) itself and the loss of a classification prediction machine learning model (such as a classifier) that predicts a classification label based on the loss parameter of the anomaly detection machine learning model (such as the autoencoder).

Continuing from the healthcare example above, autoencoders alone may effectively model stochastic parts of a patient trajectory (which appear as diagnostic odysseys) but do not perform well at identifying those diagnostic odysseys that are the specific results of rare disease. Classifiers alone may effectively predict instances in which the right diagnoses (for rare disease) are found in the medical record. As such, by combining the autoencoder and the classifier, various embodiments of the present disclosure preserve strengths of both with respect to predicting rare disease and improve accuracy and reliability in generating predictions.

While the description above provides an example of prediction-based operation, it is noted that the scope of the present disclosure is not limited to the description above. In some examples, an example method may comprise one or more additional and/or alternative prediction-based operations. For example, after training the anomaly detection machine learning model based on the composite loss parameter, a client computing entity may transmit a data object predictive analysis request to the classification label prediction computing entity. As an example, the data object predictive analysis request may comprise data objects that comprise healthcare related data and/or information, demographic data and/or information, socioeconomic data and/or information, and/or the like associated with a user, similar to those described above. In such an example, the classification label prediction computing entity may generate a predicted classification label that indicates whether the user is likely to have a rare disease.

Additionally, or alternatively, the classification label prediction computing entity may generate one or more diagnostic reports based on the predictions, display/provide one or more resources based on the predictions, generate one or more action scripts based on predictions, and/or generate alerts or reminders based on the predictions.

Referring back to FIG. 7, subsequent to and/or in response to step/operation 711, the example method 700 proceeds to step/operation 713 and ends.

### A. Example Normal Prediction Loss Parameter Generation

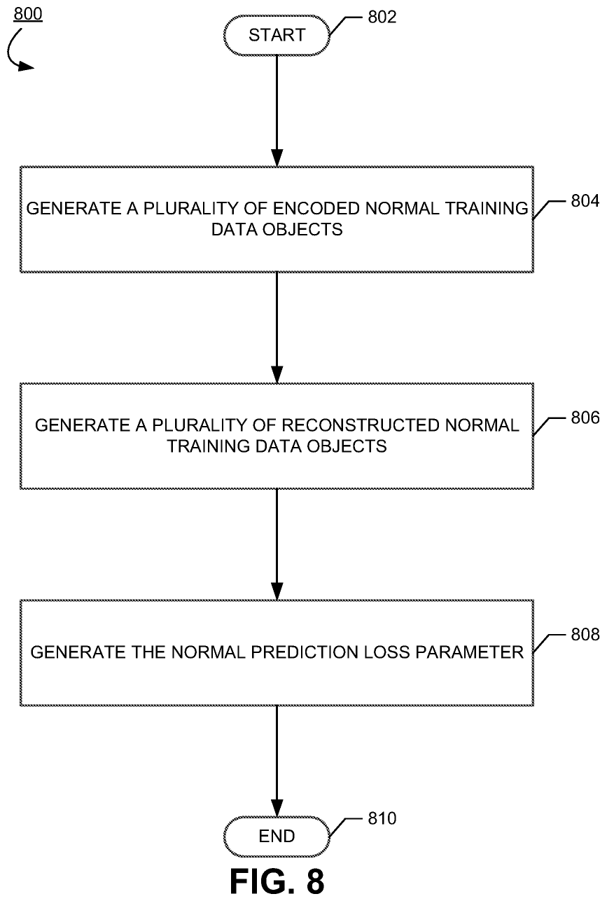

As described above, there are technical challenges, deficiencies, and problems associated with machine learning models, and various example embodiments of the present disclosure overcome such technical challenges, deficiencies, and problems. For example, FIG. 8 illustrates an example flowchart diagram of an example method 800 for generating normal prediction loss parameters in accordance with some embodiments discussed herein.

The example method 800 may improve accuracy and reliability of machine learning model generated predictions by generating a plurality of encoded normal training data objects, generating a plurality of reconstructed normal training data objects, and generating the normal prediction loss parameter. In some embodiments, the normal prediction loss parameter may be provided as an input in generating the global classification loss parameter, which is a part of the composite loss parameter for training the machine learning model, thereby overcoming technical challenges and difficulties associated with training machine learning models based on class-imbalanced dataset.

As shown in FIG. 8, the example method 800 starts at step/operation 802. Subsequent to and/or in response to step/operation 802, the example method 800 proceeds to step/operation 804. At step/operation 804, a computing entity (such as, but not limited to, the classification label prediction computing entity 106 described above in connection with FIG. 1 and FIG. 2 and/or the client computing entity 102A described above in connection with FIG. 1 and FIG. 3) generates a plurality of encoded normal training data objects.

In some embodiments, the plurality of encoded normal training data objects is generated based on a plurality of normal training data objects. In some embodiments, the plurality of encoded normal training data objects is generated by one or more encoding layers of an anomaly detection machine learning model (such as, but not limited to, an autoencoder).

For example, the one or more encoding layers of the anomaly detection machine learning model generate the plurality of encoded normal training data objects by compressing the plurality of normal training data objects into an encoded representation that is orders of magnitude smaller than plurality of normal training data objects.

While the description above provides an example of an anomaly detection machine learning model in the form of an autoencoder, it is noted that the scope of the present disclosure is not limited to the description above.

Referring back to FIG. 8, subsequent to and/or in response to step/operation 804, the example method 800 proceeds to step/operation 806. At step/operation 806, a computing entity (such as, but not limited to, the classification label prediction computing entity 106 described above in connection with FIG. 1 and FIG. 2 and/or the client computing entity 102A described above in connection with FIG. 1 and FIG. 3) generates a plurality of reconstructed normal training data objects.

In some embodiments, the plurality of reconstructed normal training data objects is generated based on reconstructing the plurality of encoded normal training data objects generated at step/operation 804. In some embodiments, the plurality of reconstructed normal training data objects is generated by one or more decoding layers of an anomaly detection machine learning model (such as, but not limited to, an autoencoder).

For example, the one or more decoding layers of the anomaly detection machine learning model receive the plurality of encoded normal training data objects and decompress encoded normal training data objects back from their decoded forms. Through decompression, the one or more decoding layers of the anomaly detection machine learning model generate the plurality of reconstructed normal training data objects.

Referring back to FIG. 8, subsequent to and/or in response to step/operation 806, the example method 800 proceeds to step/operation 808. At step/operation 808, a computing entity (such as, but not limited to, the classification label prediction computing entity 106 described above in connection with FIG. 1 and FIG. 2 and/or the client computing entity 102A described above in connection with FIG. 1 and FIG. 3) generates the normal prediction loss parameter.

As described above, the normal prediction loss parameter indicates a reconstruction loss measure associated with the anomaly detection machine learning model in reconstructing a plurality of normal training data objects that is associated with the normal classification label. In some embodiments, the normal prediction loss parameter is generated based on the plurality of normal training data objects and the plurality of reconstructed normal training data objects.

For example, the anomaly detection machine learning model (such as, but not limited to, an autoencoder) may compare (a) the original normal training data objects that are provided to the anomaly detection machine learning model for generating the encoded normal training data objects at step/operation 804 with (b) the reconstructed normal training data objects that are generated at step/operation 806. Based on the comparison, the anomaly detection machine learning model determines the normal prediction loss parameter based on a measure of how close the reconstructed normal training data objects are to the original normal training data objects.

Referring back to FIG. 8, subsequent to and/or in response to step/operation 808, the example method 800 proceeds to step/operation 810 and ends.

### B. Example Anomaly Prediction Loss Parameter Generation

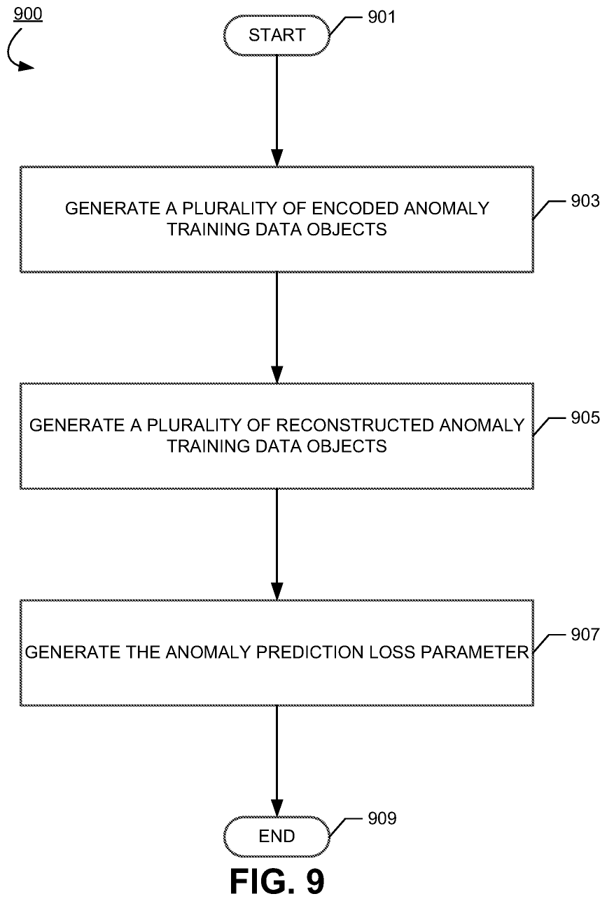

As described above, there are technical challenges, deficiencies, and problems associated with machine learning models, and various example embodiments of the present disclosure overcome such technical challenges, deficiencies, and problems. For example, FIG. 9 illustrates an example flowchart diagram of an example method 900 for generating anomaly prediction loss parameters in accordance with some embodiments discussed herein.

For example, the example method 900 may improve accuracy and reliability of machine learning model generated predictions by generating a plurality of encoded anomaly training data objects, generating a plurality of reconstructed anomaly training data objects, and generating the anomaly prediction loss parameter. In some embodiments, the anomaly prediction loss parameter may be provided as an input for generating a global classification loss parameter, which is a part of the composite loss parameter for training the machine learning model, thereby overcoming technical challenges and difficulties associated with training machine learning models based on class-imbalanced dataset.

As shown in FIG. 9, the example method 900 starts at step/operation 901. Subsequent to and/or in response to step/operation 901, the example method 900 proceeds to step/operation 903. At step/operation 903, a computing entity (such as, but not limited to, the classification label prediction computing entity 106 described above in connection with FIG. 1 and FIG. 2 and/or the client computing entity 102A described above in connection with FIG. 1 and FIG. 3) generates a plurality of encoded anomaly training data objects.

In some embodiments, the plurality of encoded anomaly training data objects is generated based on a plurality of anomaly training data objects. In some embodiments, the plurality of encoded anomaly training data objects is generated by one or more encoding layers of an anomaly detection machine learning model (such as, but not limited to, an autoencoder).

For example, the one or more encoding layers of the anomaly detection machine learning model generate the plurality of encoded anomaly training data objects by compressing the plurality of anomaly training data objects into an encoded representation that is orders of magnitude smaller than plurality of anomaly training data objects.

While the description above provides an example of the anomaly detection machine learning model in the form of an autoencoder, it is noted that the scope of the present disclosure is not limited to the description above.

Referring back to FIG. 9, subsequent to and/or in response to step/operation 903, the example method 900 proceeds to step/operation 905. At step/operation 905, a computing entity (such as, but not limited to, the classification label prediction computing entity 106 described above in connection with FIG. 1 and FIG. 2 and/or the client computing entity 102A described above in connection with FIG. 1 and FIG. 3) generates a plurality of reconstructed anomaly training data objects.

In some embodiments, the plurality of reconstructed anomaly training data objects is generated based on reconstructing the plurality of encoded anomaly training data objects generated at step/operation 903. In some embodiments, the plurality of reconstructed anomaly training data objects is generated by one or more decoding layers of an anomaly detection machine learning model (such as, but not limited to, an autoencoder).

For example, the one or more decoding layers of the anomaly detection machine learning model receive the plurality of encoded anomaly training data objects and decompress encoded anomaly training data objects back from their decoded forms. Through decompression, the one or more decoding layers of the anomaly detection machine learning model generate the plurality of reconstructed anomaly training data objects.

Referring back to FIG. 9, subsequent to and/or in response to step/operation 905, the example method 900 proceeds to step/operation 907. At step/operation 907, a computing entity (such as, but not limited to, the classification label prediction computing entity 106 described above in connection with FIG. 1 and FIG. 2 and/or the client computing entity 102A described above in connection with FIG. 1 and FIG. 3) generates the anomaly prediction loss parameter.

As described above, the anomaly prediction loss parameter indicates a reconstruction loss measure associated with the anomaly detection machine learning model in reconstructing a plurality of anomaly training data objects that is associated with the anomaly classification label. In some embodiments, the anomaly prediction loss parameter is generated based on the plurality of anomaly training data objects and the plurality of reconstructed anomaly training data objects.

For example, the anomaly detection machine learning model (such as, but not limited to, an autoencoder) may compare (a) the original anomaly training data objects that are provided to the anomaly detection machine learning model for generating the encoded anomaly training data objects at step/operation 903 with (b) the reconstructed anomaly training data objects that are generated at step/operation 905. Based on the comparison, the anomaly detection machine learning model determines the anomaly prediction loss parameter based on how close the reconstructed anomaly training data objects are to the original anomaly training data objects.

Referring back to FIG. 9, subsequent to and/or in response to step/operation 907, the example method 900 proceeds to step/operation 909 and ends.

### C. Example Global Classification Loss Parameter Generation

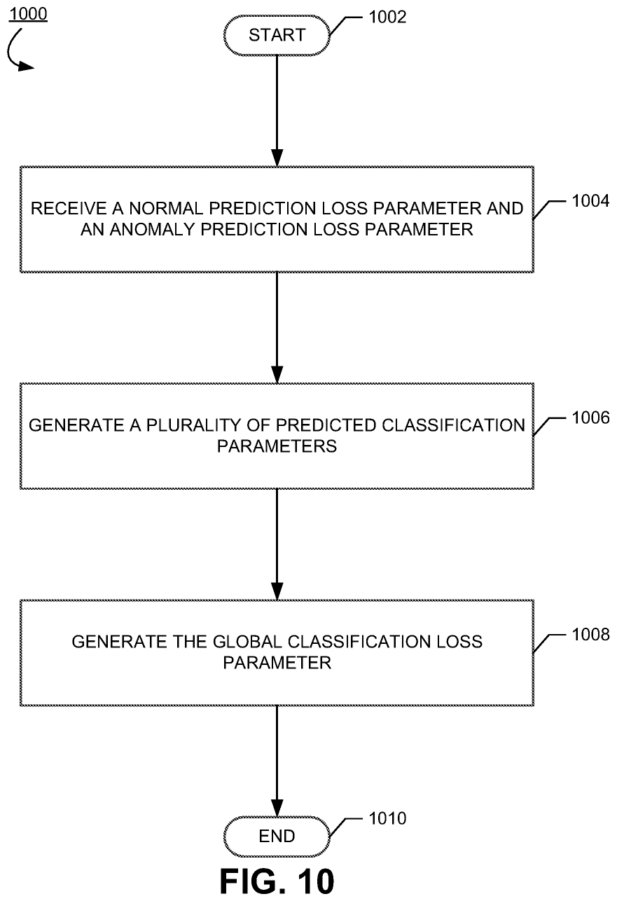

As described above, there are technical challenges, deficiencies, and problems associated with machine learning models, and various example embodiments of the present disclosure overcome such technical challenges, deficiencies, and problems. For example, FIG. 10 illustrates an example flowchart diagram of an example method 1000 for generating global classification loss parameters in accordance with some embodiments discussed herein.

For example, the example method 1000 may improve accuracy and reliability of machine learning model generated predictions by receiving a normal prediction loss parameter and an anomaly prediction loss parameter, generating a plurality of predicted classification parameters, and generating the global classification loss parameter. In some embodiments, the global classification loss parameter may be provided as a part of the composite loss parameter for training the machine learning model, thereby overcoming technical challenges and difficulties associated with training machine learning models based on class-imbalanced dataset.

As shown in FIG. 10, the example method 1000 starts at step/operation 1002. Subsequent to and/or in response to step/operation 1002, the example method 1000 proceeds to step/operation 1004. At step/operation 1004, a computing entity (such as, but not limited to, the classification label prediction computing entity 106 described above in connection with FIG. 1 and FIG. 2 and/or the client computing entity 102A described above in connection with FIG. 1 and FIG. 3) receives a normal prediction loss parameter and an anomaly prediction loss parameter.

Similar to the various examples described above, the normal prediction loss parameter and the anomaly prediction loss parameter may be generated by an anomaly detection machine learning model (such as, but not limited to, an autoencoder). In some embodiments, the normal prediction loss parameter indicates a reconstruction loss measure associated with the anomaly detection machine learning model in reconstructing a plurality of normal training data objects. In some embodiments, the anomaly prediction loss parameter indicates a reconstruction loss measure associated with the anomaly detection machine learning model in reconstructing a plurality of anomaly training data objects.

Referring back to FIG. 10, subsequent to and/or in response to step/operation 1004, the example method 1000 proceeds to step/operation 1006. At step/operation 1006, a computing entity (such as, but not limited to, the classification label prediction computing entity 106 described above in connection with FIG. 1 and FIG. 2 and/or the client computing entity 102A described above in connection with FIG. 1 and FIG. 3) generates a plurality of predicted classification parameters.

In some embodiments, the plurality of predicted classification parameters are generated based on inputting, to the classification prediction machine learning model, the normal prediction loss parameter and the anomaly prediction loss parameter that are received at step/operation 1004, as well as the normal training data objects and the anomaly training data objects that are used by the anomaly detection machine learning model to generate the normal prediction loss parameter and the anomaly prediction loss parameter.

For example, the classification prediction machine learning model may comprise an artificial neural network, similar to the various examples described above. In some embodiments, the classification prediction machine learning model is trained to generate predicted classification parameters based on the labeled training data objects (including the normal training data objects and the anomaly training data objects), the normal prediction loss parameter and the anomaly prediction loss parameter. Based on labeled training data objects and loss parameters, the classification prediction machine learning model may generate predictions on classification parameters associated with the labeled training data object as the predicted classification parameters.

As an example in the healthcare context, the classification prediction machine learning model may analyze the normal prediction loss parameter, the anomaly prediction loss parameter, and data and/or information associated with the labeled training data object (such as, but not limited to, healthcare related data and/or information, demographic data and/or information, socioeconomic data and/or information, and/or the like) other than the associated labeled classification parameter. Based on such data and/or information and loss parameters, the classification prediction machine learning model may generate a prediction of the classification parameter associated with the labeled training data object as the predicted classification parameter (for example, a normal classification label that indicates the user is not predicted to have a rare disease or an anomaly classification label that indicates the user is predicted have the rare disease) associated with the labeled training data object.

Referring back to FIG. 10, subsequent to and/or in response to step/operation 1006, the example method 1000 proceeds to step/operation 1008. At step/operation 1008, a computing entity (such as, but not limited to, the classification label prediction computing entity 106 described above in connection with FIG. 1 and FIG. 2 and/or the client computing entity 102A described above in connection with FIG. 1 and FIG. 3) generates the global classification loss parameter.

In some embodiments, the global classification loss parameter indicates a loss measure associated with the classification prediction machine learning model in predicting the plurality of labeled classification parameters associated with the plurality of labeled training data objects. In some embodiments, the classification prediction machine learning model generates the global classification loss parameter based on the plurality of predicted classification parameters and the plurality of labeled classification parameters associated with the labeled training data objects.

As described above, the classification prediction machine learning model generates a predicted classification parameter for a labeled training data object based not only on the labeled training data object itself, but also on the normal prediction loss parameter and the anomaly prediction loss parameter. In some embodiments, the classification prediction machine learning model compares the predicted classification parameter associated with the labeled training data object and the labeled classification parameter associated with the labeled training data object and generates the global classification loss parameter based on the comparison.

Continuing from the healthcare example above, the classification prediction machine learning model may compare the predicted classification parameters and the labeled classification parameters and determine the level of inaccuracies in predicting the classification parameters by the classification prediction machine learning model based on the normal prediction loss parameter and the anomaly prediction loss parameter.

Referring back to FIG. 10, subsequent to and/or in response to step/operation 1008, the example method 1000 proceeds to step/operation 1010 and ends.

### D. Example Machine Learning Model Training

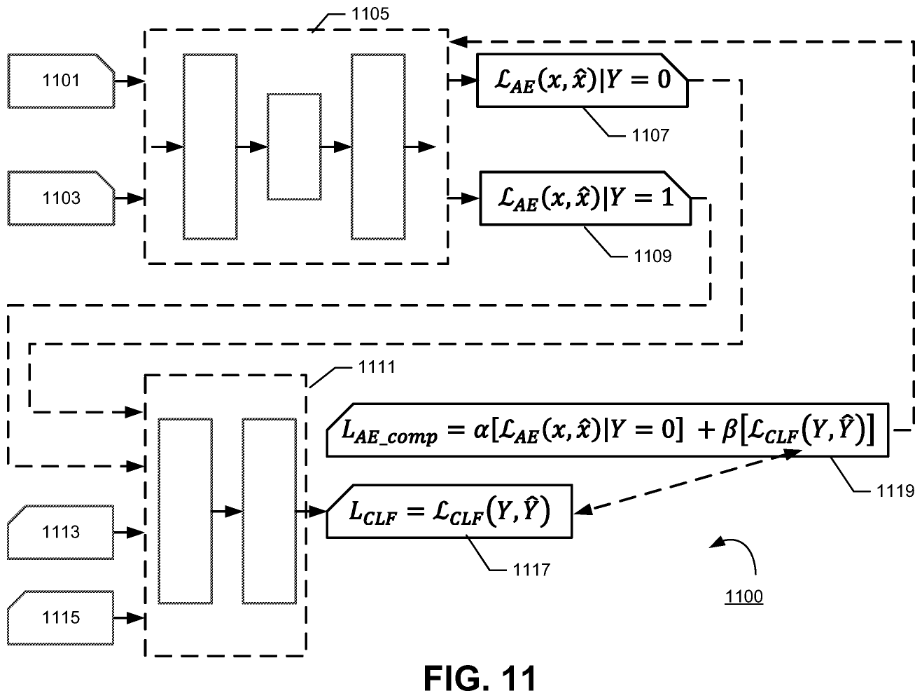

Referring now to FIG. 11, an operational example of a classification label prediction system 1100 in accordance with some embodiments discussed herein is provided. In the example shown in FIG. 11, the classification label prediction system 1100 comprises an anomaly detection machine learning model 1105 (such as, but not limited to, an autoencoder) and a classification prediction machine learning model 1111 (such as, but not limited to, a classifier).

As described above, autoencoders and classifiers each have their technical advantages and disadvantages in generating predictions. In the example of predicting rare diseases as described above, autoencoders alone may effectively model stochastic parts of a patient trajectory (which appear as diagnostic odysseys) but may not do well at identifying those diagnostic odysseys that are the specific result of the rare disease. Classifiers alone may effectively predict instances in which the right diagnoses (for rare disease) are found in the medical record but may underperform at processing stochastic and noisy elements in the data. Various embodiments of the present disclosure overcome those technical challenges and difficulties in generating accurate and reliable predictions based on combining the autoencoder and the classifier in a way that preserves the strengths of both with respect to predicting rare disease.

In the example shown in FIG. 11, the anomaly detection machine learning model 1105 may receive normal training data objects 1101 (x|Y=0) and anomaly training data objects 1103 (x|Y=1). In some embodiments, the anomaly detection machine learning model 1105 may generate normal prediction loss parameter 1107 ( [symbol] _{AE}(x,\hat{x})|Y=0) and anomaly prediction loss parameter 1109 ( [symbol] _{AE}(x,\hat{x})|Y=1) based on encoding and reconstructing the normal training data objects 1101 (x|Y=0) and anomaly training data objects 1103 (x|Y=1), similar to various examples described above.

In some embodiments, the normal prediction loss parameter 1107 ( [symbol] _{AE}(x,\hat{x})|Y=0) and the anomaly prediction loss parameter 1109 ( [symbol] _{AE}(x,\hat{x})|Y=1) are provided as inputs to the classification prediction machine learning model 1111, in addition to the normal training data objects 1113 (x, [symbol] _{AE}(x,\hat{x})|Y=0) and the anomaly training data objects 1115 (x, [symbol] _{AE}(x,\hat{x})|Y=1). In some embodiments, the classification prediction machine learning model 1111 generates the global classification loss parameter 1117 (L_{CLF}= [symbol] _{CLF}(Y,Ŷ)) based on predicting classification parameters associated with the normal training data objects 1113 (x, [symbol] _{AE}(x,\hat{x})|Y=0) and the anomaly training data objects 1115 (x, [symbol] _{AE}(x,\hat{x})|Y=1). In some embodiments, the classification prediction machine learning model 1111 predicts classification parameters based on the normal prediction loss parameter 1107 ( [symbol] _{AE}(x,\hat{x})|Y=0) and the anomaly prediction loss parameter 1109 ( [symbol] _{AE}(x,\hat{x})|Y=1), similar to the various examples described above. In some embodiments, not only the normal prediction loss parameter may be added to the input, but also the classification prediction machine learning model 1111 may use x, (x,c) or c along with [symbol] _{AE}.

While the description above provides example syntax associated with various parameters of the present disclosure, it is noted that the scope of the present disclosure is not limited to the description above.

In some embodiments, the classification label prediction system 1100 calculates a composite loss parameter 1119 (L_{AE_comp}) based on the following equation:

$${L}_{AE\_comp} = α [ {ℒ}_{A E} ( x , \hat{x} ) \vert Y = 0 ] + β [ {L}_{C L F} ( Y , \hat{Y} ) ]$$

In some embodiments, the composite loss parameter 1119 is provided to the anomaly detection machine learning model 1105 as feedback for training the anomaly detection machine learning model 1105. By training the anomaly detection machine learning model 1105 (for example, an autoencoder) based on minimizing the composite loss parameter 1119 that is calculated using both the loss of the autoencoder itself (e.g., the normal prediction loss parameter 1107) and the loss (e.g., the global classification loss parameter 1117) of the classifier that predicts a label based on the autoencoder loss (e.g., the normal prediction loss parameter 1107 and/or the anomaly prediction loss parameter 1109), various embodiments of the present disclosure improve the accuracy and reliability in generating predictions.

TABLE 2 below further illustrates some feature differences between the anomaly detection machine learning model 1105 and the classification prediction machine learning model 1111:

TABLE 2
EXAMPLE MACHINE LEARNING MODEL FEATURES

| Machine | | | | |
|---|---|---|---|---|
| Learning | | | Relevant | Loss |
| Mode | Goal | Inputs | Outputs | Function |
| Anomaly | Learn To | Real Data from | Per-Sample | Own Cross- |
| detection | Reconstruct Only | Normal Class | Loss Is Fed as | Entropy Plus |
| Machine | the Normal | (Which Contributes | Feature to | Classifier |
| Learning | Class, And | to Loss Function) | Binary | Loss |
| Model 1105 | Compute Losses | And Anomaly | Classifier | |
| | for Normal and | Class | | |
| | Anomaly Data | | | |
| Classification | Discriminate | Real Data from | Sends Loss to | Cross- |
| Prediction | Between Normal | Normal Class and | Anomaly | Entropy |
| Machine | and Anomaly | Anomaly Class; | detection | |
| Learning | Classes | Reconstruction | Machine | |
| Model 1111 | | Losses from Base | Learning | |
| | | Anomaly detection | Model | |
| | | Machine Learning | | |
| | | Model | | |

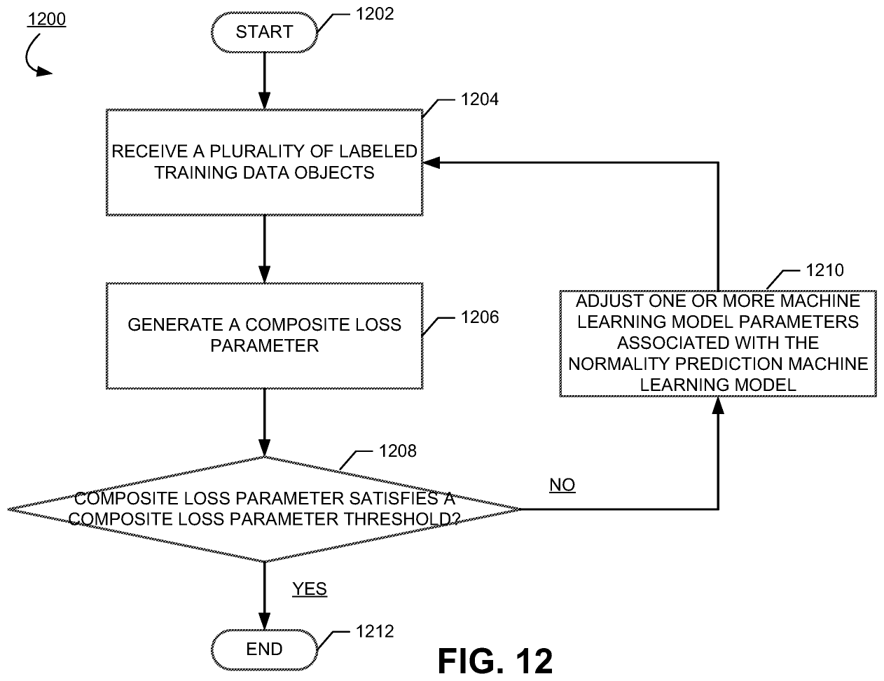

As described above, there are technical challenges, deficiencies, and problems associated with machine learning models, and various example embodiments of the present disclosure overcome such technical challenges, deficiencies, and problems. For example, FIG. 12 illustrates an example flowchart diagram of an example method 1200 for training an example anomaly detection machine learning model in accordance with some embodiments discussed herein. In some embodiments, the example method 1200 may train the machine learning model to overcome technical challenges and difficulties associated with class-imbalanced dataset and generate accurate and reliable predictions by at least minimizing the composite loss parameter.

As shown in FIG. 12, the example method 1200 starts at step/operation 1202. Subsequent to and/or in response to step/operation 1202, the example method 1200 proceeds to step/operation 1204. At step/operation 1204, a computing entity (such as, but not limited to, the classification label prediction computing entity 106 described above in connection with FIG. 1 and FIG. 2 and/or the client computing entity 102A described above in connection with FIG. 1 and FIG. 3) receives a plurality of labeled training data objects.

In some embodiments, the plurality of labeled training data objects comprises a plurality of normal training data objects and a plurality of anomaly training data objects, similar to the various examples described above.

Referring back to FIG. 12, subsequent to and/or in response to step/operation 1204, the example method 1200 proceeds to step/operation 1206. At step/operation 1206, a computing entity (such as, but not limited to, the classification label prediction computing entity 106 described above in connection with FIG. 1 and FIG. 2 and/or the client computing entity 102A described above in connection with FIG. 1 and FIG. 3) generates a composite loss parameter.

In some embodiments, the composite loss parameter comprises a weighted combination of the normal prediction loss parameter and the global classification loss parameter based on the normal prediction weight parameter and the global classification weight parameter. In some embodiments, the composite loss parameter is determined based on implementing both an anomaly detection machine learning model and a classification prediction machine learning model, similar to the various examples described above.

Referring back to FIG. 12, subsequent to and/or in response to step/operation 1206, the example method 1200 proceeds to step/operation 1208. At step/operation 1208, a computing entity (such as, but not limited to, the classification label prediction computing entity 106 described above in connection with FIG. 1 and FIG. 2 and/or the client computing entity 102A described above in connection with FIG. 1 and FIG. 3) determines whether the composite loss parameter determined at step/operation 1206 satisfies a composite loss parameter threshold.

As an example, if the composite loss parameter is higher than the composite loss parameter threshold, the composite loss parameter may be determined to be not satisfying the composite loss parameter threshold. In such an example, the composite loss parameter indicates a high level of performance loss associated with generating predictions and a low level of confidence in the accuracy of predictions. If the composite loss parameter is not higher than the composite loss parameter threshold, the composite loss parameter may be determined to be satisfying the composite loss parameter threshold. In such an example, the composite loss parameter indicates a low level of performance loss associated with generating predictions and a high level of confidence in the accuracy of predictions.

If, at step/operation 1208, the computing entity determines that the composite loss parameter determined at step/operation 1206 does not satisfy the composite loss parameter threshold, the example method 1200 proceeds to step/operation 1210. At step/operation 1210, a computing entity (such as, but not limited to, the classification label prediction computing entity 106 described above in connection with FIG. 1 and FIG. 2 and/or the client computing entity 102A described above in connection with FIG. 1 and FIG. 3) adjusts one or more machine learning model parameters associated with the anomaly detection machine learning model.

In some embodiments, the one or more machine learning model parameters associated with the anomaly detection machine learning model may be adjusted based on the composite loss parameter. For example, the computing entity may cause one or more adjustments of the anomaly detection machine learning model in an attempt to reduce the composite loss parameter.

Referring back to FIG. 12, subsequent to and/or in response to step/operation 1210, the example method 1200 returns step/operation 1204. As such, FIG. 12 illustrates an example feedback loop for training the anomaly detection machine learning model in the classification label prediction system based on reducing the composite loss parameter, providing technical benefits and improvements such as, but not limited to, improved accuracy and reliability in generating predictions.

Referring back to FIG. 12, if, at step/operation 1208, the computing entity determines that the composite loss parameter determined at step/operation 1206 satisfies the composite loss parameter threshold, the example method 1200 proceeds to step/operation 1212 and ends.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising: receiving, by one or more processors, a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label; generating, by the one or more processors, a normal prediction loss parameter associated with the normal classification label and an anomaly prediction loss parameter associated with the anomaly classification label based on inputting the plurality of labeled training data objects to an anomaly detection machine learning model; generating, by the one or more processors and using a classification prediction machine learning model, a global classification loss parameter based on the plurality of labeled training data objects, the normal prediction loss parameter, and the anomaly prediction loss parameter; generating, by the one or more processors, a composite loss parameter based on the normal prediction loss parameter, the global classification loss parameter, a normal prediction weight parameter, and a global classification weight parameter; and initiating, by the one or more processors, the performance of one or more prediction-based operations based on the anomaly detection machine learning model and the composite loss parameter.

Example 2. The computer-implemented method of any of the preceding examples, further comprising selecting, by the one or more processors, a plurality of normal training data objects and a plurality of anomaly training data objects from the plurality of labeled training data objects, wherein (a) a normal training data object of the plurality of normal training data objects is associated with the normal classification label, and (b) an anomaly training data object of the plurality of anomaly training data objects is associated with the anomaly classification label.

Example 3. The computer-implemented method of any of the preceding examples, wherein a normal training data object count associated with the plurality of normal training data objects is larger than an anomaly training data object count associated with the plurality of anomaly training data objects.

Example 4. The computer-implemented method of any of the preceding examples, wherein a ratio between the normal training data object count and the anomaly training data object count is 4:1.

Example 5. The computer-implemented method of any of the preceding examples, wherein the anomaly detection machine learning model comprises an artificial neural network.

Example 6. The computer-implemented method of any of the preceding examples, wherein the anomaly detection machine learning model comprises an autoencoder.

Example 7. The computer-implemented method of any of the preceding examples, wherein the anomaly detection machine learning model comprises one or more encoding layers and one or more decoding layers.

Example 8. The computer-implemented method of any of the preceding examples, wherein the normal prediction loss parameter indicates a reconstruction loss measure associated with the anomaly detection machine learning model in reconstructing a plurality of normal training data objects from the plurality of labeled training data objects that is associated with the normal classification label.

Example 9. The computer-implemented method of any of the preceding examples, further comprising: generating, by the one or more processors, a plurality of encoded normal training data objects based on the plurality of normal training data objects; generating, by the one or more processors, a plurality of reconstructed normal training data objects based on the plurality of encoded normal training data objects; and generating, by the one or more processors, the normal prediction loss parameter based on the plurality of normal training data objects and the plurality of reconstructed normal training data objects.

Example 10. The computer-implemented method of any of the preceding examples, wherein the anomaly prediction loss parameter indicates a reconstruction loss measure associated with the anomaly detection machine learning model in reconstructing a plurality of anomaly training data objects from the plurality of labeled training data objects that is associated with the anomaly classification label.

Example 11. The computer-implemented method of any of the preceding examples, further comprising: generating, by the one or more processors, a plurality of encoded anomaly training data objects based on the plurality of anomaly training data objects that is associated with the anomaly classification label; generating, by the one or more processors, a plurality of reconstructed anomaly training data objects based on the plurality of encoded anomaly training data objects; and generating, by the one or more processors, the anomaly prediction loss parameter based on the plurality of anomaly training data objects and the plurality of reconstructed anomaly training data objects.

Example 12. The computer-implemented method of any of the preceding examples, wherein the global classification loss parameter indicates a loss measure associated with the classification prediction machine learning model in predicting the plurality of labeled classification parameters associated with the plurality of labeled training data objects.

Example 13. The computer-implemented method of any of the preceding examples, wherein the classification prediction machine learning model comprises one or more input layers and one or more output layers.

Example 14. The computer-implemented method of any of the preceding examples, further comprising: generating, by the one or more processors, a plurality of predicted classification parameters associated with the plurality of labeled training data objects based on the normal prediction loss parameter and the anomaly prediction loss parameter; and generating, by the one or more processors, the global classification loss parameter based on the plurality of predicted classification parameters and the plurality of labeled classification parameters.

Example 15. The computer-implemented method of any of the preceding examples, wherein the composite loss parameter comprises a weighted combination of the normal prediction loss parameter and the global classification loss parameter based on the normal prediction weight parameter and the global classification weight parameter.

Example 16. The computer-implemented method of any of the preceding examples, further comprising adjusting, by the one or more processors, one or more machine learning model parameters associated with the anomaly detection machine learning model based on the composite loss parameter.

Example 17. A computing apparatus comprising memory and one or more processors communicatively coupled to the memory, the one or more processors configured to: receive a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label; generate, using an anomaly detection machine learning model and the plurality of labeled training data objects, (a) a normal prediction loss parameter associated with the normal classification label and (b) an anomaly prediction loss parameter associated with the anomaly classification label; generate, using a classification prediction machine learning model, a global classification loss parameter based on the plurality of labeled training data objects, the normal prediction loss parameter, and the anomaly prediction loss parameter; generate a composite loss parameter based on the normal prediction loss parameter, the global classification loss parameter, a normal prediction weight parameter, and a global classification weight parameter; and initiate the performance of one or more prediction-based operations based on the anomaly detection machine learning model and the composite loss parameter.

Example 18. The computing apparatus comprising memory of any of the preceding examples, wherein the one or more processors are further configured to select a plurality of normal training data objects and a plurality of anomaly training data objects from the plurality of labeled training data objects, wherein (a) a normal training data object of the plurality of normal training data objects is associated with the normal classification label, and (b) an anomaly training data object of the plurality of anomaly training data objects is associated with the anomaly classification label.

Example 19. The computing apparatus comprising memory of any of the preceding examples, wherein a normal training data object count associated with the plurality of normal training data objects is larger than an anomaly training data object count associated with the plurality of anomaly training data objects.

Example 20. The computing apparatus comprising memory of any of the preceding examples, wherein a ratio between the normal training data object count and the anomaly training data object count is 4:1.

Example 21. The computing apparatus comprising memory of any of the preceding examples, wherein the anomaly detection machine learning model comprises an artificial neural network.

Example 22. The computing apparatus comprising memory of any of the preceding examples, wherein the anomaly detection machine learning model comprises an autoencoder.

Example 23. The computing apparatus comprising memory of any of the preceding examples, wherein the anomaly detection machine learning model comprises one or more encoding layers and one or more decoding layers.

Example 24. The computing apparatus comprising memory of any of the preceding examples, wherein the normal prediction loss parameter indicates a reconstruction loss measure associated with the anomaly detection machine learning model in reconstructing a plurality of normal training data objects from the plurality of labeled training data objects that is associated with the normal classification label.

Example 25. The computing apparatus comprising memory of any of the preceding examples, wherein the one or more processors are further configured to: generate a plurality of encoded normal training data objects based on the plurality of normal training data objects; generate a plurality of reconstructed normal training data objects based on the plurality of encoded normal training data objects; and generate the normal prediction loss parameter based on the plurality of normal training data objects and the plurality of reconstructed normal training data objects.

Example 26. The computing apparatus comprising memory of any of the preceding examples, wherein the anomaly prediction loss parameter indicates a reconstruction loss measure associated with the anomaly detection machine learning model in reconstructing a plurality of anomaly training data objects from the plurality of labeled training data objects that is associated with the anomaly classification label.

Example 27. The computing apparatus comprising memory of any of the preceding examples, wherein the one or more processors are further configured to: generate a plurality of encoded anomaly training data objects based on the plurality of anomaly training data objects that is associated with the anomaly classification label; generate, by the one or more processors, a plurality of reconstructed anomaly training data objects based on the plurality of encoded anomaly training data objects; and generate, by the one or more processors, the anomaly prediction loss parameter based on the plurality of anomaly training data objects and the plurality of reconstructed anomaly training data objects.

Example 28. The computing apparatus comprising memory of any of the preceding examples, wherein the global classification loss parameter indicates a loss measure associated with the classification prediction machine learning model in predicting the plurality of labeled classification parameters associated with the plurality of labeled training data objects.

Example 29. The computing apparatus comprising memory of any of the preceding examples, wherein the classification prediction machine learning model comprises one or more input layers and one or more output layers.

Example 30. The computing apparatus comprising memory of any of the preceding examples, wherein the one or more processors are further configured to: generate, by the one or more processors, a plurality of predicted classification parameters associated with the plurality of labeled training data objects based on the normal prediction loss parameter and the anomaly prediction loss parameter; and generate, by the one or more processors, the global classification loss parameter based on the plurality of predicted classification parameters and the plurality of labeled classification parameters.

Example 31. The computing apparatus comprising memory of any of the preceding examples, wherein the composite loss parameter comprises a weighted combination of the normal prediction loss parameter and the global classification loss parameter based on the normal prediction weight parameter and the global classification weight parameter.

Example 32. The computing apparatus comprising memory of any of the preceding examples, wherein the one or more processors are further configured to: adjust one or more machine learning model parameters associated with the anomaly detection machine learning model based on the composite loss parameter.

Example 33. One or more non-transitory computer-readable storage media including instructions that, when executed by one or more processors, cause the one or more processors to: receive a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label; generate, using an anomaly detection machine learning model and the plurality of labeled training data objects, (a) a normal prediction loss parameter associated with the normal classification label and (b) an anomaly prediction loss parameter associated with the anomaly classification label; generate, using a classification prediction machine learning model, a global classification loss parameter based on the plurality of labeled training data objects, the normal prediction loss parameter, and the anomaly prediction loss parameter; generate a composite loss parameter based on the normal prediction loss parameter, the global classification loss parameter, a normal prediction weight parameter, and a global classification weight parameter; and initiate the performance of one or more prediction-based operations based on the anomaly detection machine learning model and the composite loss parameter.

Example 34. The one or more non-transitory computer-readable storage media of any of the preceding examples, wherein the instructions further cause the one or more processors to select a plurality of normal training data objects and a plurality of anomaly training data objects from the plurality of labeled training data objects, wherein (a) a normal training data object of the plurality of normal training data objects is associated with the normal classification label, and (b) an anomaly training data object of the plurality of anomaly training data objects is associated with the anomaly classification label.

Example 35. The one or more non-transitory computer-readable storage media of any of the preceding examples, wherein a normal training data object count associated with the plurality of normal training data objects is larger than an anomaly training data object count associated with the plurality of anomaly training data objects.

Example 36. The one or more non-transitory computer-readable storage media of any of the preceding examples, wherein a ratio between the normal training data object count and the anomaly training data object count is 4:1.

Example 37. The one or more non-transitory computer-readable storage media of any of the preceding examples, wherein the anomaly detection machine learning model comprises an artificial neural network.

Example 38. The one or more non-transitory computer-readable storage media of any of the preceding examples, wherein the anomaly detection machine learning model comprises an autoencoder.

Example 39. The one or more non-transitory computer-readable storage media of any of the preceding examples, wherein the anomaly detection machine learning model comprises one or more encoding layers and one or more decoding layers.

Example 40. The one or more non-transitory computer-readable storage media of any of the preceding examples, wherein the normal prediction loss parameter indicates a reconstruction loss measure associated with the anomaly detection machine learning model in reconstructing a plurality of normal training data objects from the plurality of labeled training data objects that is associated with the normal classification label.

Example 41. The one or more non-transitory computer-readable storage media of any of the preceding examples, wherein the instructions further cause the one or more processors to: generate a plurality of encoded normal training data objects based on the plurality of normal training data objects; generate a plurality of reconstructed normal training data objects based on the plurality of encoded normal training data objects; and generate the normal prediction loss parameter based on the plurality of normal training data objects and the plurality of reconstructed normal training data objects.

Example 42. The one or more non-transitory computer-readable storage media of any of the preceding examples, wherein the anomaly prediction loss parameter indicates a reconstruction loss measure associated with the anomaly detection machine learning model in reconstructing a plurality of anomaly training data objects from the plurality of labeled training data objects that is associated with the anomaly classification label.

Example 43. The one or more non-transitory computer-readable storage media of any of the preceding examples, wherein the instructions further cause the one or more processors to: generate a plurality of encoded anomaly training data objects based on the plurality of anomaly training data objects that is associated with the anomaly classification label; generate, by the one or more processors, a plurality of reconstructed anomaly training data objects based on the plurality of encoded anomaly training data objects; and generate, by the one or more processors, the anomaly prediction loss parameter based on the plurality of anomaly training data objects and the plurality of reconstructed anomaly training data objects.

Example 44. The one or more non-transitory computer-readable storage media of any of the preceding examples, wherein the global classification loss parameter indicates a loss measure associated with the classification prediction machine learning model in predicting the plurality of labeled classification parameters associated with the plurality of labeled training data objects.

Example 45. The one or more non-transitory computer-readable storage media of any of the preceding examples, wherein the classification prediction machine learning model comprises one or more input layers and one or more output layers.

Example 46. The one or more non-transitory computer-readable storage media of any of the preceding examples, wherein the instructions further cause the one or more processors to: generate, by the one or more processors, a plurality of predicted classification parameters associated with the plurality of labeled training data objects based on the normal prediction loss parameter and the anomaly prediction loss parameter; and generate, by the one or more processors, the global classification loss parameter based on the plurality of predicted classification parameters and the plurality of labeled classification parameters.

Example 47. The one or more non-transitory computer-readable storage media of any of the preceding examples, wherein the composite loss parameter comprises a weighted combination of the normal prediction loss parameter and the global classification loss parameter based on the normal prediction weight parameter and the global classification weight parameter.

Example 48. The one or more non-transitory computer-readable storage media of any of the preceding examples, wherein the instructions further cause the one or more processors to: adjust one or more machine learning model parameters associated with the anomaly detection machine learning model based on the composite loss parameter.

Example 49. The computer-implemented method of any of the preceding examples, wherein the labeled classification parameter of the plurality of labeled classification parameters indicates at least one of a first classification label, a second classification label, or a third classification label.

Example 50. The computing apparatus of any of the preceding examples, wherein the labeled classification parameter of the plurality of labeled classification parameters indicates at least one of a first classification label, a second classification label, or a third classification label.

Example 51. The one or more non-transitory computer-readable storage media of any of the preceding examples, wherein the labeled classification parameter of the plurality of labeled classification parameters indicates at least one of a first classification label, a second classification label, or a third classification label.

1. A computer-implemented method comprising:
receiving, by one or more processors, a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label;
generating, by the one or more processors and using an anomaly detection machine learning model and the plurality of labeled training data objects, (a) a normal prediction loss parameter associated with the normal classification label and (b) an anomaly prediction loss parameter associated with the anomaly classification label;
generating, by the one or more processors and using a classification prediction machine learning model, a global classification loss parameter based on the plurality of labeled training data objects, the normal prediction loss parameter, and the anomaly prediction loss parameter;
generating, by the one or more processors, a composite loss parameter based on the normal prediction loss parameter, the global classification loss parameter, a normal prediction weight parameter, and a global classification weight parameter; and
initiating, by the one or more processors, the performance of one or more prediction-based operations based on the anomaly detection machine learning model and the composite loss parameter.

2. The computer-implemented method of claim 1, further comprising selecting a plurality of normal training data objects and a plurality of anomaly training data objects from the plurality of labeled training data objects, wherein (a) a normal training data object of the plurality of normal training data objects is associated with the normal classification label, and (b) an anomaly training data object of the plurality of anomaly training data objects is associated with the anomaly classification label.

3. The computer-implemented method of claim 2, wherein a normal training data object count associated with the plurality of normal training data objects is larger than an anomaly training data object count associated with the plurality of anomaly training data objects.

4. The computer-implemented method of claim 1, wherein the normal prediction loss parameter indicates a reconstruction loss measure associated with the anomaly detection machine learning model in reconstructing a plurality of normal training data objects from the plurality of labeled training data objects from the plurality of labeled training data objects that is associated with the normal classification label.

5. The computer-implemented method of claim 4, further comprising:
generating, by the one or more processors, a plurality of encoded normal training data objects based on the plurality of normal training data objects;
generating, by the one or more processors, a plurality of reconstructed normal training data objects based on the plurality of encoded normal training data objects; and
generating, by the one or more processors, the normal prediction loss parameter based on the plurality of normal training data objects and the plurality of reconstructed normal training data objects.

6. The computer-implemented method of claim 1, wherein the anomaly prediction loss parameter indicates a reconstruction loss measure associated with the anomaly detection machine learning model in reconstructing a plurality of anomaly training data objects from the plurality of labeled training data objects that is associated with the anomaly classification label.

7. The computer-implemented method of claim 6, further comprising:
generating, by the one or more processors, a plurality of encoded anomaly training data objects based on the plurality of anomaly training data objects that is associated with the anomaly classification label;
generating, by the one or more processors, a plurality of reconstructed anomaly training data objects based on the plurality of encoded anomaly training data objects; and
generating, by the one or more processors, the anomaly prediction loss parameter based on the plurality of anomaly training data objects and the plurality of reconstructed anomaly training data objects.

8. A computing apparatus comprising memory and one or more processors communicatively coupled to the memory, the one or more processors configured to:
receive a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label;
generate, using an anomaly detection machine learning model and the plurality of labeled training data objects, (a) a normal prediction loss parameter associated with the normal classification label and (b) an anomaly prediction loss parameter associated with the anomaly classification label;
generate, using a classification prediction machine learning model, a global classification loss parameter based on the plurality of labeled training data objects, the normal prediction loss parameter, and the anomaly prediction loss parameter;
generate a composite loss parameter based on the normal prediction loss parameter, the global classification loss parameter, a normal prediction weight parameter, and a global classification weight parameter; and
initiate the performance of one or more prediction-based operations based on the anomaly detection machine learning model and the composite loss parameter.

9. The computing apparatus of claim 8, wherein the one or more processors are further configured to select a plurality of normal training data objects and a plurality of anomaly training data objects from the plurality of labeled training data objects, wherein (a) a normal training data object of the plurality of normal training data objects is associated with the normal classification label, and (b) an anomaly training data object of the plurality of anomaly training data objects is associated with the anomaly classification label.

10. The computing apparatus of claim 9, wherein a normal training data object count associated with the plurality of normal training data objects is larger than an anomaly training data object count associated with the plurality of anomaly training data objects.

11. The computing apparatus of claim 8, wherein the normal prediction loss parameter indicates a reconstruction loss measure associated with the anomaly detection machine learning model in reconstructing a plurality of normal training data objects from the plurality of labeled training data objects that is associated with the normal classification label.

12. The computing apparatus of claim 11, wherein the one or more processors are further configured to:
generate a plurality of encoded normal training data objects based on the plurality of normal training data objects;
generate a plurality of reconstructed normal training data objects based on the plurality of encoded normal training data objects; and
generate the normal prediction loss parameter based on the plurality of normal training data objects and the plurality of reconstructed normal training data objects.

13. The computing apparatus of claim 8, wherein the anomaly prediction loss parameter indicates a reconstruction loss measure associated with the anomaly detection machine learning model in reconstructing a plurality of anomaly training data objects from the plurality of labeled training data objects that is associated with the anomaly classification label.

14. The computing apparatus of claim 13, wherein the one or more processors are further configured to:
generate a plurality of encoded anomaly training data objects based on the plurality of anomaly training data objects that is associated with the anomaly classification label;
generate a plurality of reconstructed anomaly training data objects based on the plurality of encoded anomaly training data objects; and
generate the anomaly prediction loss parameter based on the plurality of anomaly training data objects and the plurality of reconstructed anomaly training data objects.

15. One or more non-transitory computer-readable storage media including instructions that, when executed by one or more processors, cause the one or more processors to:
receive a plurality of labeled training data objects, wherein (a) a labeled training data object of the plurality of labeled training data objects is associated with one of a plurality of labeled classification parameters, and (b) a labeled classification parameter of the plurality of labeled classification parameters indicates at least one of a normal classification label or an anomaly classification label;
generate, using an anomaly detection machine learning model and the plurality of labeled training data objects, (a) a normal prediction loss parameter associated with the normal classification label and (b) an anomaly prediction loss parameter associated with the anomaly classification label;
generate, using a classification prediction machine learning model, a global classification loss parameter based on the plurality of labeled training data objects, the normal prediction loss parameter, and the anomaly prediction loss parameter;
generate a composite loss parameter based on the normal prediction loss parameter, the global classification loss parameter, a normal prediction weight parameter, and a global classification weight parameter; and
initiate the performance of one or more prediction-based operations based on the anomaly detection machine learning model and the composite loss parameter.

16. The one or more non-transitory computer-readable storage media of claim 15, wherein the instructions further cause the one or more processors to select a plurality of normal training data objects and a plurality of anomaly training data objects from the plurality of labeled training data objects, wherein (a) a normal training data object of the plurality of normal training data objects is associated with the normal classification label, and (b) an anomaly training data object of the plurality of anomaly training data objects is associated with the anomaly classification label.

17. The one or more non-transitory computer-readable storage media of claim 16, wherein a normal training data object count associated with the plurality of normal training data objects is larger than an anomaly training data object count associated with the plurality of anomaly training data objects.

18. The one or more non-transitory computer-readable storage media of claim 15, wherein the normal prediction loss parameter indicates a reconstruction loss measure associated with the anomaly detection machine learning model in reconstructing a plurality of normal training data objects from the plurality of labeled training data objects that is associated with the normal classification label.

19. The one or more non-transitory computer-readable storage media of claim 18, wherein the instructions further cause the one or more processors to:
generate a plurality of encoded normal training data objects based on the plurality of normal training data objects;
generate a plurality of reconstructed normal training data objects based on the plurality of encoded normal training data objects; and
generate the normal prediction loss parameter based on the plurality of normal training data objects and the plurality of reconstructed normal training data objects.

20. The one or more non-transitory computer-readable storage media of claim 15, wherein the anomaly prediction loss parameter indicates a reconstruction loss measure associated with the anomaly detection machine learning model in reconstructing a plurality of anomaly training data objects from the plurality of labeled training data objects that is associated with the anomaly classification label.
